(19) United States
(12) Patent Application Publication
(10) Pub. No.: US 2015/0242779 A1
(43) Pub. Date: Aug. 27, 2015

(54) COMPUTERIZED COMPLEX SYSTEM EVENT ASSESSMENT, PROJECTION AND CONTROL

(71) Applicant: Projectioneering, LLC, Frederick, MD (US)

(72) Inventor: JOHN H. HNATIO, UNION BRIDGE, VA (US)

(21) Appl. No.: 14/638,796

(22) Filed: Mar. 4, 2015

Related U.S. Application Data
(63) Continuation of application No. 12/948,597, filed on Nov. 17, 2010, now abandoned.

(51) Int. Cl. G06Q 10/06; G06Q 50/26

(52) U.S. Cl. CPC G06Q 10/0635; G06Q 50/26

(57) ABSTRACT

Systems, methods and computer readable media for computerized event risk assessment, event projection and control of events associated with complex systems are disclosed. The assessment can include using statistically processed survey data to determine risk category performance. Event projection can be based on data retrieved from a past events database. Control can include real-time control of subsystems within the complex system and providing reports and visualizations. The visualizations can include profile graphs, bar graphs, dashboards and hyperbolic mapping.

### FIELD OF THE INVENTION

Embodiments relate generally to computerized management of events associated with a complex system and, more particularly, to systems, methods and computer readable media for computerized complex system event risk assessment, event projection and event response/management.

### BACKGROUND

Traditional scientific inquiry techniques that rely on principles such as linearity, reductionism, certainty of measurement, reversibility and induction may be ineffective in the assessment, projection and control of complex events, systems and situations such as natural disasters, terrorist attacks, outbreaks of disease and industrial accidents. Accordingly, a system or method that incorporates a practical application of one or more traditional scientific inquiry techniques or theories may suffer from a limited ability to assess, predict and/or control complex events.

A need for a scientifically derived alternative to the continued reliance on conventional techniques for managing risk in complex systems or events was recognized. A robust approach to managing risk in complex events or systems may require integration of quantitative scientific information with qualitative human social processes in a way that provides a more effective management technique. Because of the large quantities of data typically associated with complex events or systems, a computerized method, system and computer readable medium are practical options for implementing a specific application of a complex event management method. By combining computer information processing technology with the complex event risk management techniques described herein, a tool that assists humans in the effective management of complex events, situations and systems can be provided. Embodiments were conceived in view of the above-mentioned limitations of traditional scientific inquiry techniques and applications, among other things.

### SUMMARY

One or more embodiments can include a computer-based system for managing risk in a complex system. The computer-based system has a processor coupled to a data storage device and an interface adapted to exchange data with another device. The data storage device can have software instructions stored on it. The software instructions being adapted to be executed by the processor and to cause the processor to perform operations. The operations include retrieving historical event data, risk event categories and performance criteria from the data storage device, and determining event paths for each event that presents a risk. The operations also include weighting critical nodes for each event path, and retrieving standards from the data storage device. The operations further include generating online surveys by triangulating standards and issuing online surveys electronically using the processor to transmit the surveys to external systems via a computer network coupled to the interface. The operations can also include receiving online survey responses electronically and scoring the responses, using the processor, to generate performance reports including an assessment of risk potential for each risk event category.

A computerized method of complex system event management can include triangulating and weighting risk event categories based on historical event data retrieved from a computer data storage, and determining and weighting performance criteria relevant to managing events for an organization. The method can also include constructing an electronic standards library based on standards retrieved from the computer data storage, and validating and testing performance criteria. The method can further include assessing client performance, projecting future events and generating event management response recommendations.

### BRIEF DESCRIPTION OF THE DRAWINGS

FIG. 1 is a diagram of a computerized event assessment, projection and control system in accordance with the present disclosure.

FIG. 2 is a diagram of a computerized event assessment, projection and control system in accordance with the present disclosure.

FIG. 3 is a chart of an exemplary method for computerized event assessment, projection and control system in accordance with the present disclosure.

FIG. 4 is a chart of an exemplary method for computerized event assessment, projection and control system in accordance with the present disclosure.

FIG. 5 is a chart showing a method of triangulating and weighting risk event categories in accordance with the present disclosure.

FIG. 6 is a chart showing a method of determining and weighting performance criteria in accordance with the present disclosure.

FIG. 7 is a chart showing a method of constructing a standards library in accordance with the present disclosure.

FIG. 8 is a chart showing a method of validating and testing performance criteria in accordance with the present disclosure.

FIG. 9 is a chart showing a method of client assessment in accordance with the present disclosure.

FIG. 10 is a chart showing a method of projecting future events as opposed to predicting, in accordance with the present disclosure.

FIG. 11 is a chart showing a method of event management or response control in accordance with the present disclosure.

FIG. 12 is a diagram of a computer system for event assessment, projection and response control in accordance with the present disclosure.

FIG. 13 is a chart showing a method for computerized event assessment, projection and control in accordance with the present disclosure.

FIG. 14 shows an exemplary dashboard-style output in accordance with the present disclosure.

FIG. 15 shows an exemplary hyperbolic map output in accordance with the present disclosure.

FIG. 16 shows an exemplary profile output in accordance with the present disclosure.

FIG. 17 shows an exemplary best investment bar graph output in accordance with the present disclosure.

FIG. 18 is an exemplary diagram of an event path analysis in accordance with the present disclosure.

FIG. 19 is an exemplary diagram of the event path of FIG. 18 including critical nodes along a threat continuum in accordance with the present disclosure.

FIG. 20 is a diagram of a critical node analysis for the exemplary arson event path of FIGS. 18 and 19, in accordance with the present disclosure.

FIG. 21 is a chart showing an exemplary critical node analysis in accordance with the present disclosure.

FIG. 22 is a chart showing an exemplary relative importance among critical nodes.

FIG. 23 is an exemplary online survey for gathering facility data in accordance with the present disclosure.

FIG. 24 is an exemplary output showing estimated likelihood of risk event in accordance with the present disclosure.

FIG. 25 is a diagram of an exemplary process for threat assessment, projection and response for a facility, for example, a school, in accordance with the present disclosure.

FIG. 26 is a continuation of the process diagram of FIG. 25.

FIG. 27 is a chart showing an exemplary threat continuum analysis of the performance criteria for a school mass shooting/hostage taking risk event category, in accordance with the present disclosure.

FIGS. 28 and 29 show exemplary risk event category weighting criteria and weighting, in accordance with the present disclosure.

FIG. 30 is an exemplary computer generated arson event action checklist in accordance with the present disclosure.

FIG. 31 is an exemplary computer generated automated emergency notification call list in accordance with the present disclosure.

FIG. 32 shows an exemplary spatial visualization of an event location in accordance with the present disclosure.

FIG. 33 shows an exemplary visualization of a target location in accordance with the present disclosure.

FIG. 34 shows exemplary computer generated incident management templates for display on a computer display and a wireless device display, in accordance with the present disclosure.

### DETAILED DESCRIPTION

While embodiments may be described in connection with various specific application examples, it will be appreciated that the methods, systems and computer readable media disclosed herein are applicable to many types of facilities, organizations, processes, scenarios and the like. For example, the complex system risk event methods, systems and computer readable media disclosed herein can be applied to schools, buildings, biotechnology production, food services (growing, production, distribution and handling), transportation, military facilities, other sensitive facilities where security may be a concern, hospitals, airports, businesses, financial institutions and the like. In general, the techniques, systems and software disclosed herein can be applied to any complex system for which risk assessment, event projection and/or event response control may be desired.

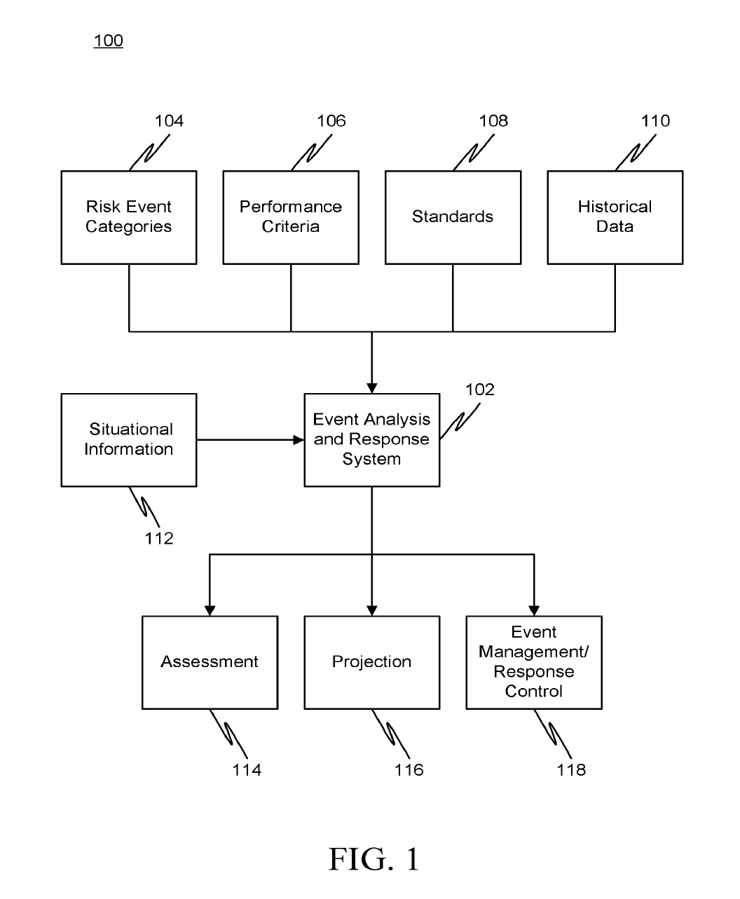

FIG. 1 is a diagram of a computerized event assessment, projection and control system 100 in accordance with the present disclosure. The system 100 includes (i.e., comprises) an event analysis and response system 102. The event analysis and response system 102 receives risk event categories 104, performance criteria 106, standards 108, historical data 110 and situational information 112. The risk event categories 104 include those categories of events that present a risk to an organization, entity and/or facility. For example, in a school setting the risk event categories can include mass shooting and/or hostage taking, food adulteration, improvised destructive devices, fire and arson, transportation safety, nuclear, biological and chemical (NBC) emergencies, other on-campus crimes, suicide, communicable disease, natural disasters, and the like. Table 1, below, illustrates the risk event categories for a school and gives some examples of risk events within each category:

TABLE 1
School Campus Risk Categories and Events

| CATEGORY | RISK EVENT |
|---|---|
| Mass shooting/Hostage taking | Hostage taking, mass shooting, other |
| Food Adulteration | Natural pathogen, poisoning, |
| | adulteration |
| Improvised destructive devices | Threat, actual bombing |
| Fires and Arson | Arson, facilities, wildfire |
| Transportation safety | Buses in use, other |
| NBC | Onsite, offsite |
| Other crimes on campus | Assault, larceny, vandalism, alcohol, |
| | drugs, other |
| Suicide | Drugs, weapons, other means |
| Communicable diseases | MRSA, measles, meningitis, |
| | influenza, STDs, other |
| Natural disasters | Tornado, hurricane, lightning, flood, |
| | earthquake, other |

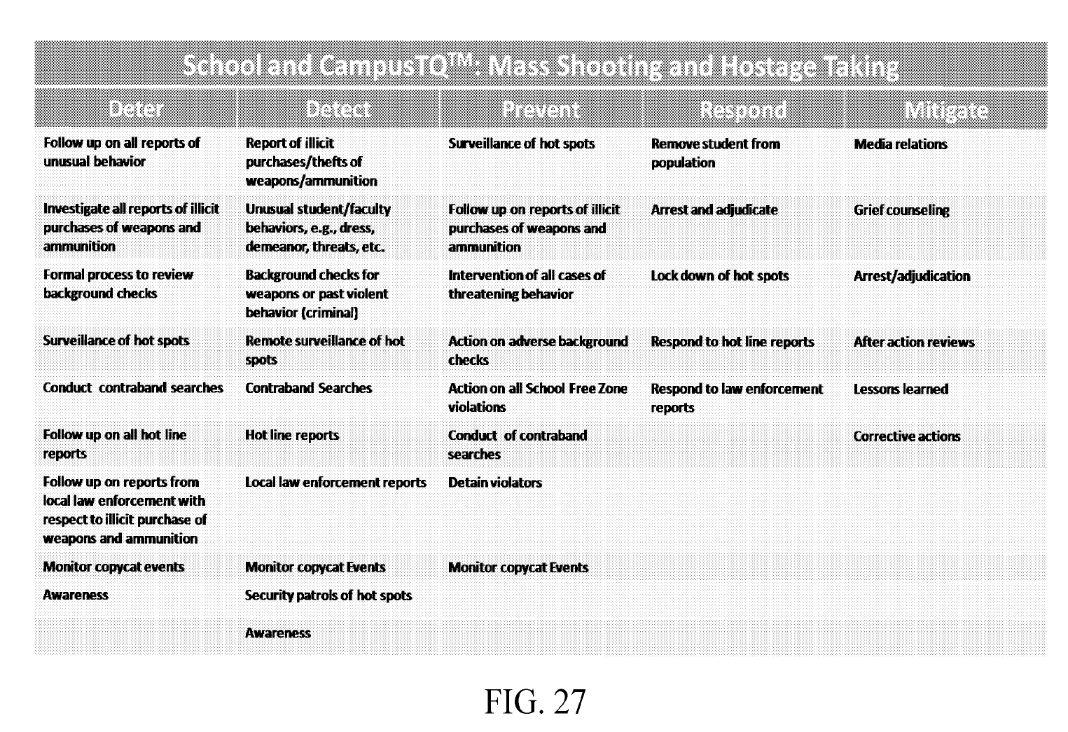

The performance criteria 106 include those actions that, when analyzed along a threat continuum, serve to deter, detect, prevent, respond and/or mitigate a specific risk category or event. For example, FIG. 27 shows an exemplary threat continuum analysis of the performance criteria for a school mass shooting/hostage taking risk event category. The standards 108 can include: federal, state and/or local rules, regulations, statutes and the like; local and/or national codes; national standards (e.g., ANSI); best industry practices; policies, procedures and processes internal to an organization, entity or facility; good manufacturing practices; and/or the like.

The historical data 110 can include data about threat or risk events that have occurred in the past. The historical data 110 can be automatically or manually gathered from sources including but not limited to: newspapers (online or print), books, television, movies, literature, crime reports, magazines and journals, and the Internet. Once gathered the historical data can be triangulated, which, in the case of historical data means to group events of the same or similar risk category. The historical data 110 can also be verified and reverse engineered. Reverse engineering, in the case of historical data, can include deconstructing an event into the steps leading up to and including the event and to also identifying the results or aftermath of the event. The historical data can be stored in a database such as the database system disclosed in co-pending application entitled “Metadata Database System and Method,” by the same inventor of the present application, and filed on Nov. 17, 2010, which is hereby incorporated herein by reference in its entirety.

The situational information 112 can include real time and/or non-real time information about an event. For example, situational information 112 could include information indicating that a shooting event is currently in progress. The situational information 112 can be used by the system to determine where along a threat continuum an event currently is and, based on that determination, to generate an appropriate output for deterring, detecting, preventing, responding to or mitigating the event.

The event analysis and response system 102 processes the received data and generates outputs. As outputs, the event analysis and response system 102 can provide a risk assessment 114, an event projection 116 and an event management/response control 118.

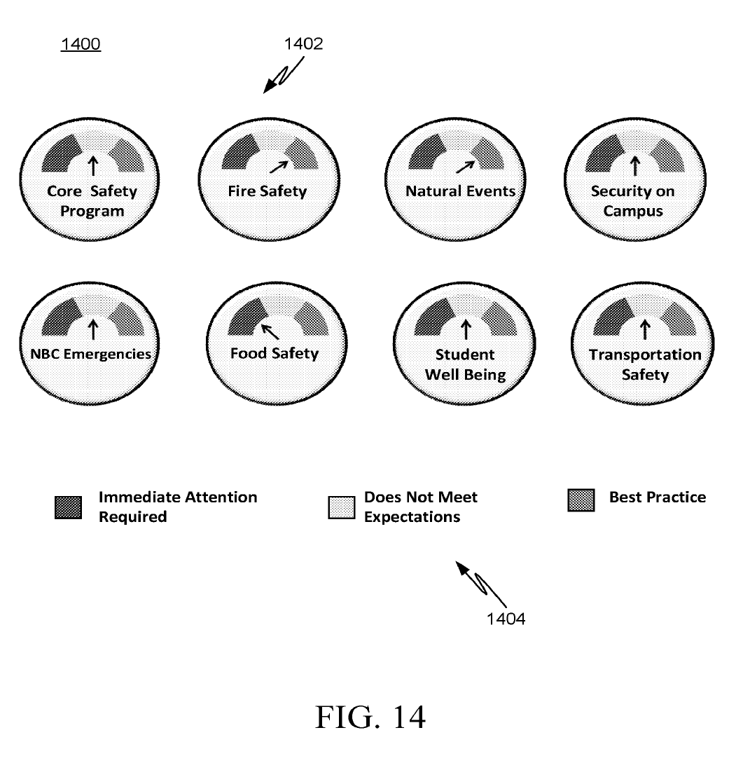

The risk assessment 114 can include such output products as reports or other visualizations showing the validation status of procedures that implement written protocols (if any). The risk assessment output can provide an indication to an organization about the preparedness of the organization to deter, detect, prevent, respond to or mitigate a risk or threat event. The risk assessment outputs can be in the form of a written report printed, electronically transmitted or displayed on a display device. The risk assessment outputs can also include one or more graphical visualizations (see, e.g., FIGS. 14-17) each adapted to convey essential information clearly.

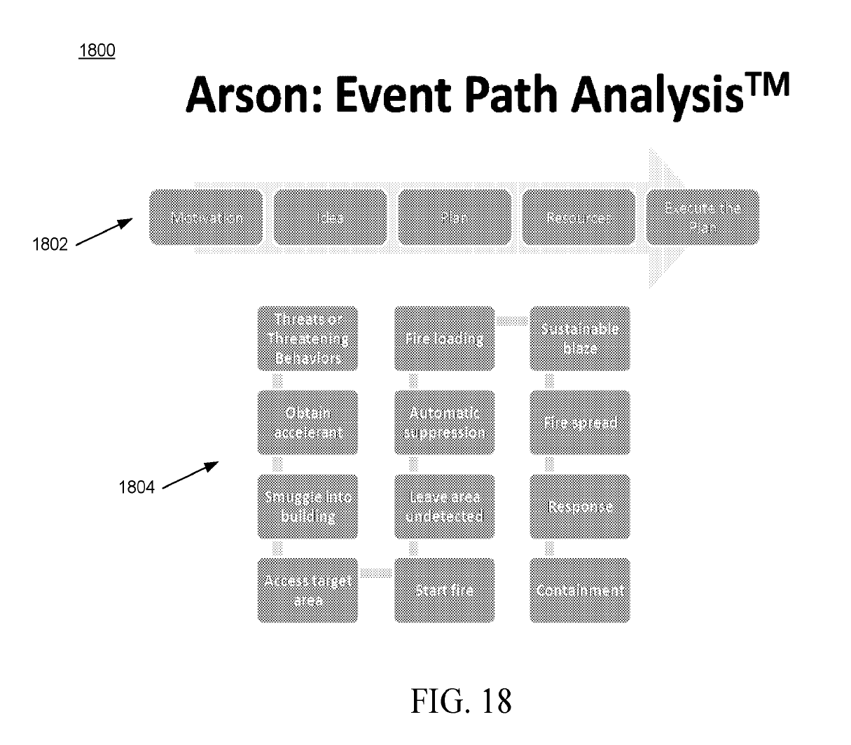

The event projection 116 output can include reports or graphical visualizations that communicate a projected event path, possible consequences of the projected event and the ability of an organization to deter, detect, prevent, respond to and/or mitigate the event based on the risk assessment of the organization. An event path can include the sequential steps leading up to and following a threat or risk event. The event projection process and outputs are discussed in greater detail below in reference to FIGS. 18-24.

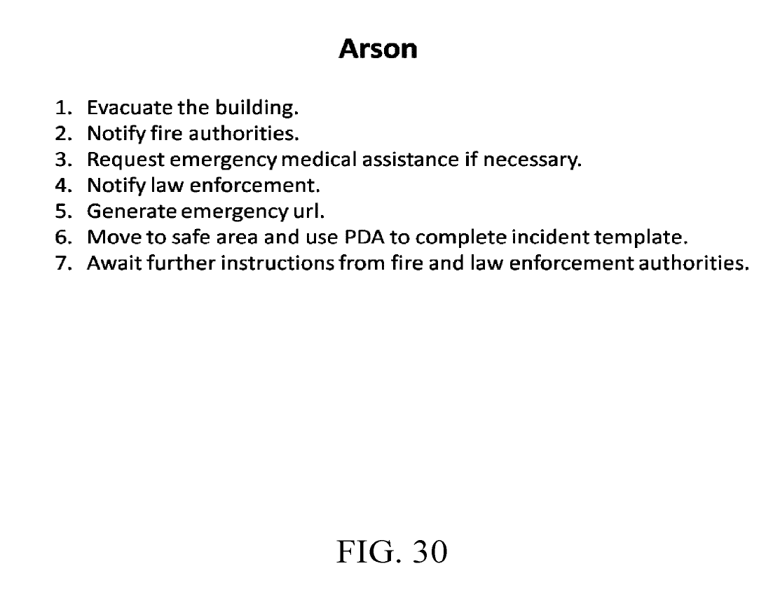

The event response/management control 118 outputs include reports, visualization and automated actions that help an organization respond to and mitigate an event that is in progress or has been completed. Event response/management outputs are discussed in greater detail below in reference to FIGS. 30-34.

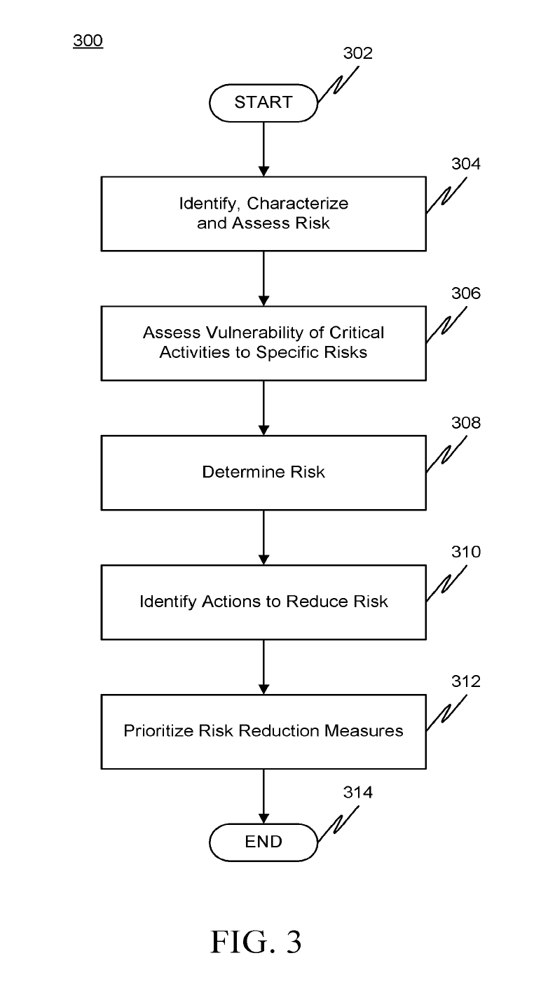

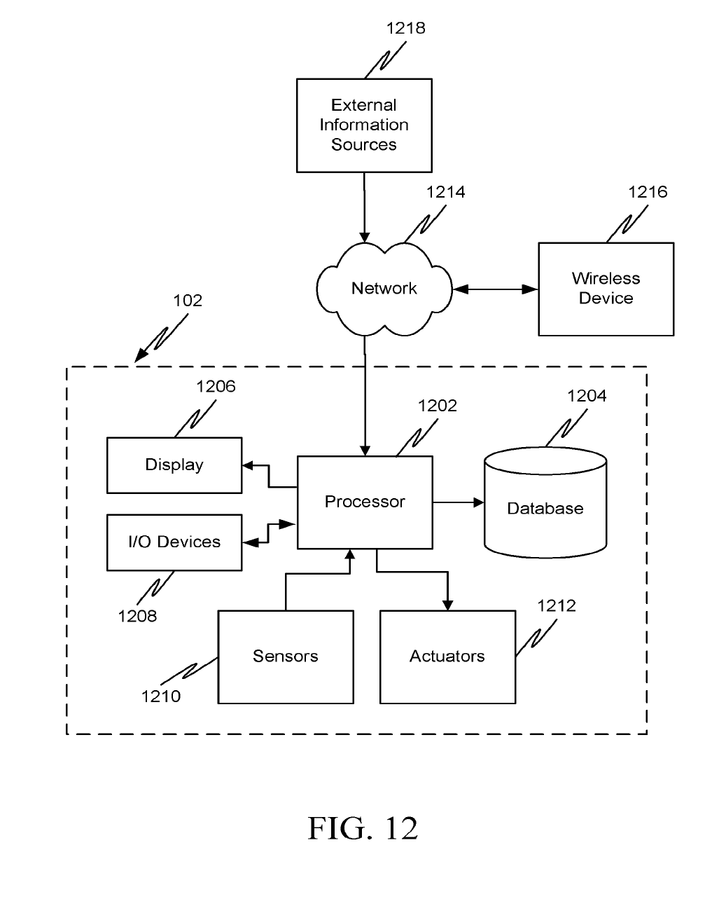

The system 100 can operate according to the processes shown in FIGS. 3, 4-11 and 13 and described below. The event analysis and response system 102 is described in greater detail below in connection with FIG. 12.

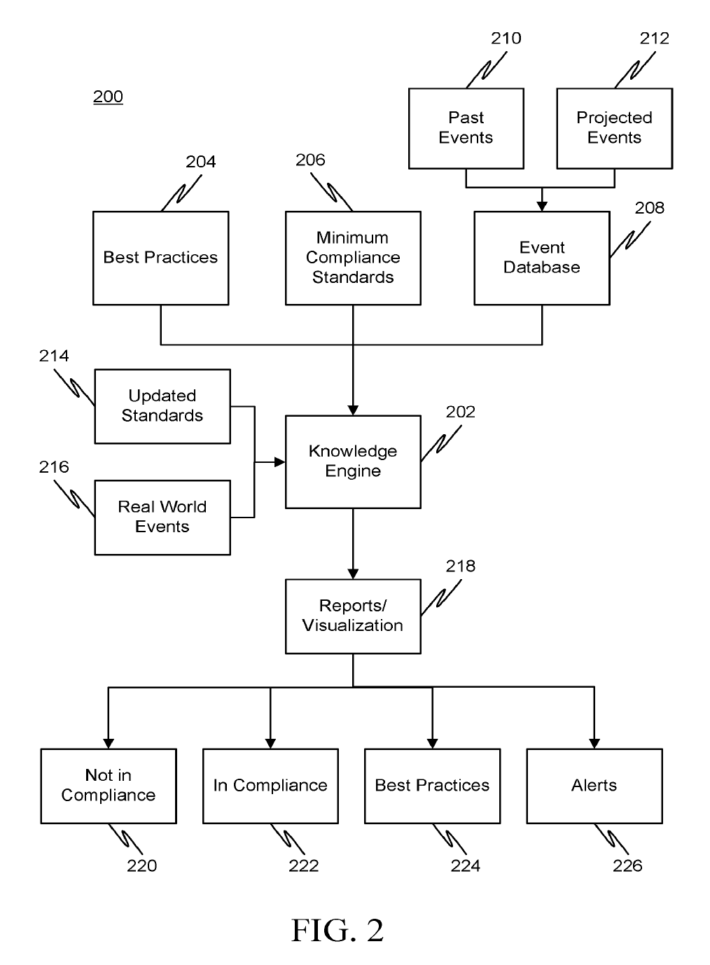

FIG. 2 shows a diagram of a computerized event assessment, projection and control system in accordance with the present disclosure. The assessment system 200 includes a knowledge engine 202 adapted to receive best practices 204, minimum compliance standards 206 and data from an event database 208. The event database 208 receives input such as past events 210 and projected events 212. The knowledge engine also receives and processes data including updated standards 214 and real world events 216.

The various inputs are statistically processed in the knowledge engine 202 along with optional data gathered from online user surveys. The online survey data can be gathered via a web service interface, email response, or the like. The online survey data can include answers to questions about general and/or specific procedures and processes of an organization. These answers are numerically scored in order to quantify the response for later use in calculating risk.

The knowledge engine 202 outputs reports and/or graphical visualizations 218 (see, e.g., FIGS. 14-17). The reports can include a level of the practices being implemented for risk events and can also indicate a capability such as not in compliance 220, in compliance 222, best practices 224 and alerts 226.

The knowledge engine 202 can be adapted to be a learning knowledge engine in that new event data, standards, best practices and minimum compliance standards can be continuously and automatically added to the knowledge engine 202 database 203. The automatically collected data can be automatically evaluated, categorized, reverse engineered and/or triangulated as discussed herein. Data can be automatically collected through such mechanisms as web crawlers and bots designed to collect specific types of information from previously known and/or newly discovered sources. Data may also be automatically collected via feed mechanisms such as RSS and/or through a web services-type interface between the knowledge engine 202 and one or more external systems. Through a machine learning mechanism, the knowledge engine 202 can adapt over time to changing risk categories and events and may be come more accurate over time with respect to known events by virtue of an increasing number of data points from which to base assessments, projections, simulations and responses.

FIG. 3 is a chart of an exemplary method 300 for computerized event assessment, projection and control system in accordance with the present disclosure. Processing begins at 302 and continues to 304.

At 304, risk associated with a complex system is identified, characterized and assessed. For example, in a school setting, the risk event categories (e.g., mass shooting and/or hostage taking, food adulteration, improvised destructive devices, fire and arson, transportation safety, nuclear, biological and chemical (NBC) emergencies, other on-campus crimes, suicide, communicable disease, natural disasters, and the like) can be identified and then specific risk events associated with each category can be identified and quantified (see, e.g., FIGS. 27, 28 and 29). It is important here to note that quantifying risk event categories sets the stage for automation of the assessment, projection and response functions discussed herein. By generating or determining quantified data points, a complex event or process that involves human behavior can be modeled and analyzed by a computerized method or system more readily and potentially with greater accuracy. Processing continues to 306.

At 306, vulnerabilities of critical activities to specific risks are assessed. For example, if a critical activity of an organization is to maintain food safety, that activity can be assessed according to specific risk event categories and events. For example, food adulteration and a nuclear, biological or chemical emergency may pose the most risk to the critical activity of maintaining food safety. Thus, in analyzing risk for a specific critical activity, those event categories posing the greatest potential risk may be weighted more heavily relative to other event categories such that identifying actions to reduce risk (see 310 below) can be made according to critical activity. Processing continues to 308.

At 308, risk is determined. By combining the characterization and assessment of risks with the analysis of the vulnerabilities of critical activities to specific risks, an overall risk assessment can be determined and ranked (e.g., according to a threat quotient for each risk event and/or category). Processing continues to 310.

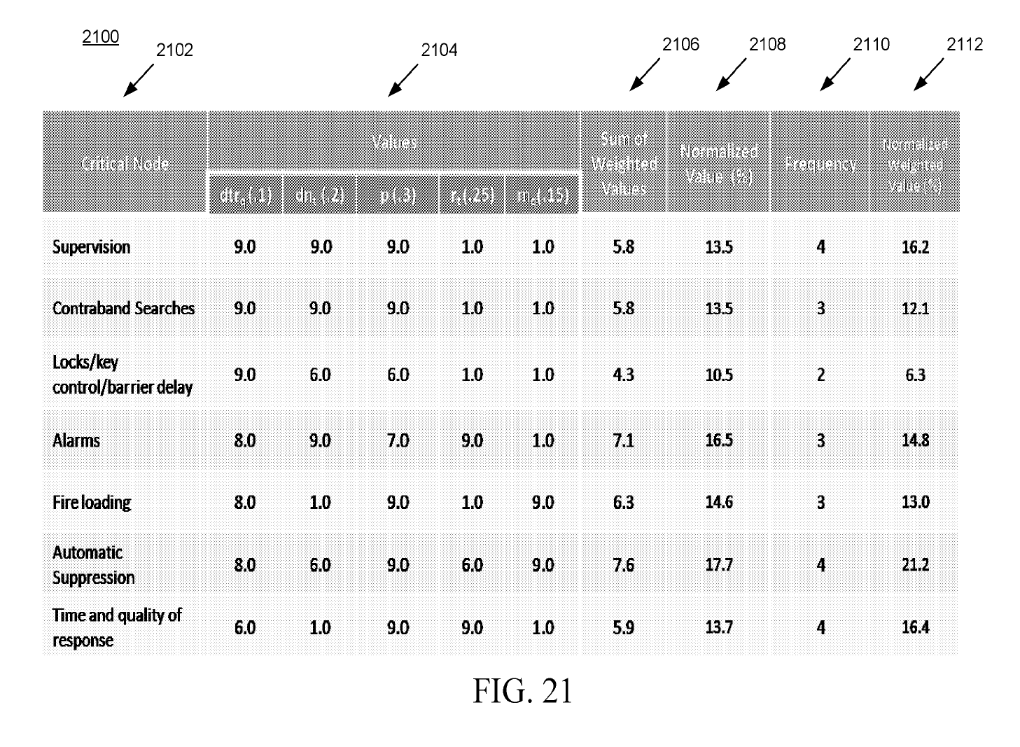

At 310, actions to reduce risk are identified. Actions or critical nodes that can play a role in deterring, detecting, preventing, responding to and/or mitigating a risk event can be identified and quantified (see, e.g., FIG. 21). Processing continues to 312.

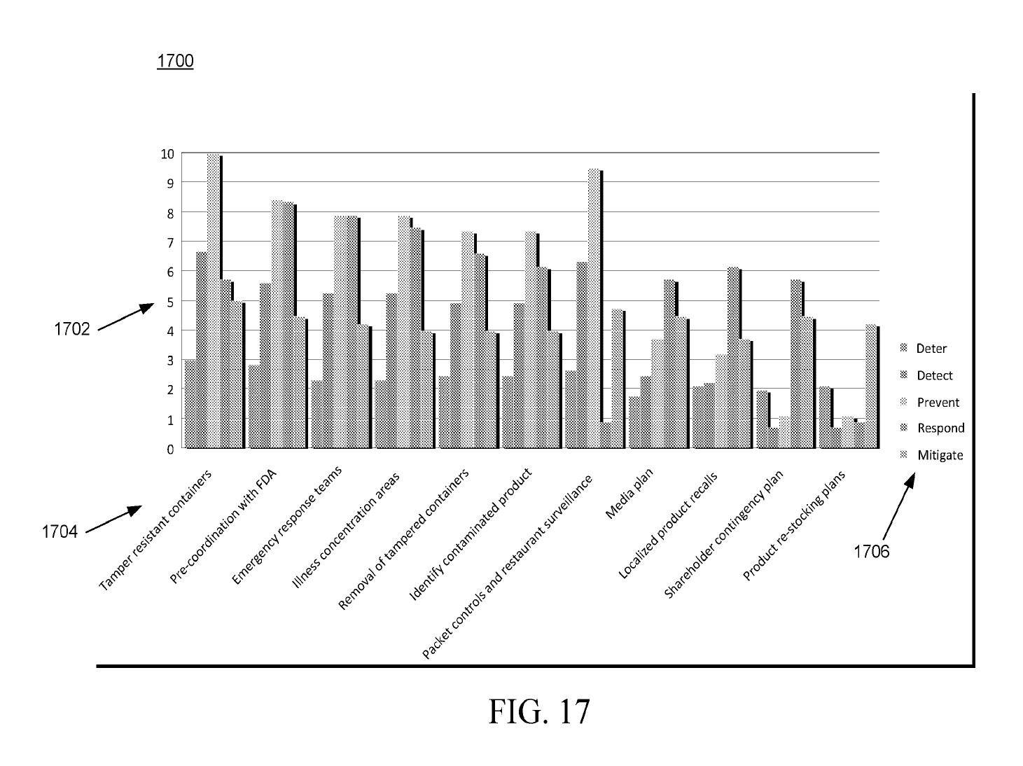

At 312, risk reduction measures are prioritized. Risk reduction measures can be prioritized according to the threat quotient of the risk being reduced, the effectiveness of the risk reduction measure, the cost of the risk reduction measure, or a combination of two or more of the above. Processing continues to 314, where processing ends. An output of the process of FIG. 3 could include reports or graphical visualizations that can be printed, displayed, or electronically transmitted (see, e.g., FIG. 17) and which can show the best investments for a specific risk event category at a specific point along the threat continuum.

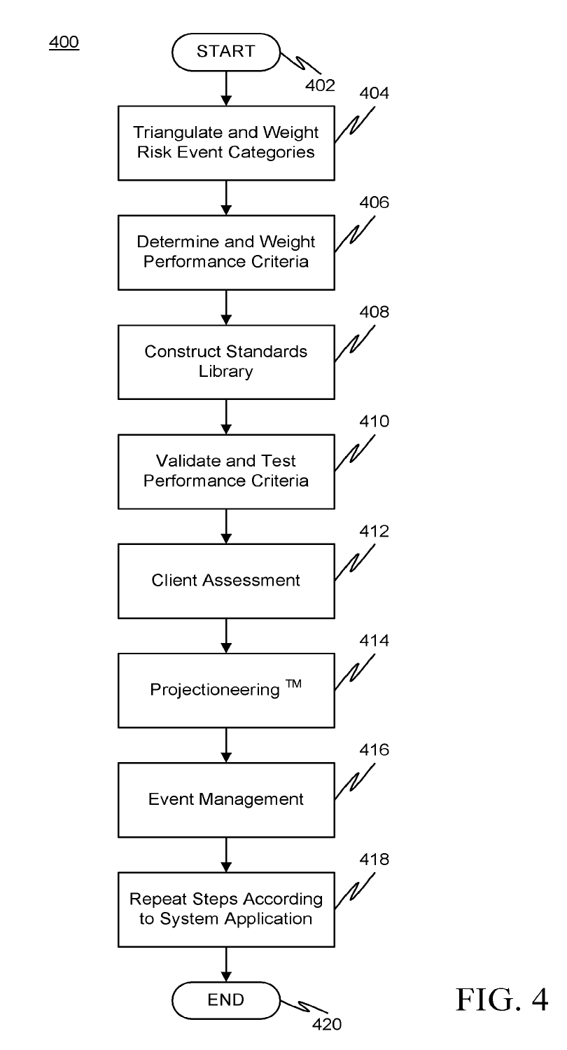

FIG. 4 is a chart of an exemplary method 400 for computerized event assessment, projection and control system in accordance with the present disclosure. Processing begins at 402 and continues to 404.

At 404, risk event categories are triangulated and weighted. In general, triangulation is the application and combination of multiple research methodologies in the study of the same phenomenon. Instead of relying on a single form of evidence or perspective as the basis for findings, multiple forms of diverse and redundant types of evidence are used to check the validity and reliability of the findings. In the case of risk event categories, risk events are triangulated by grouping like events together under a single category such as arson or natural disaster. The risk event categories can be weighted according to an event probability algorithm or a weather and geological events algorithm.

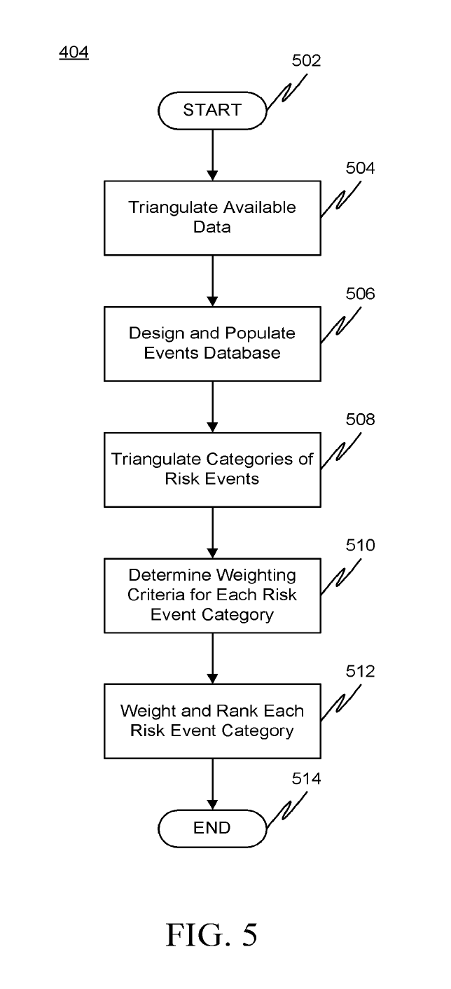

The event probability algorithm, PO f (v) (c), states that the probability of an event occurring (PO) is a function of the vulnerability of the critical node (v) and the consequences that would result if that critical node were successfully attacked or interrupted (c). The weather and geological events algorithm, (v) f PO (c), states that for natural events, the vulnerability of a critical node (v) is a function of the probability of the natural event occurring PO (e.g., based on frequency, trend analysis, modeling or the like) and the consequences (c) should a critical node be subjected to a natural event. The function for natural events differs, because the probability is not based on the vulnerability or criticality as in the vent probability algorithm for human-caused events. The probability of natural events is typically determined based on historical data and future prediction techniques. Further details of 404 are described below in connection with FIG. 5. Processing continues to 406.

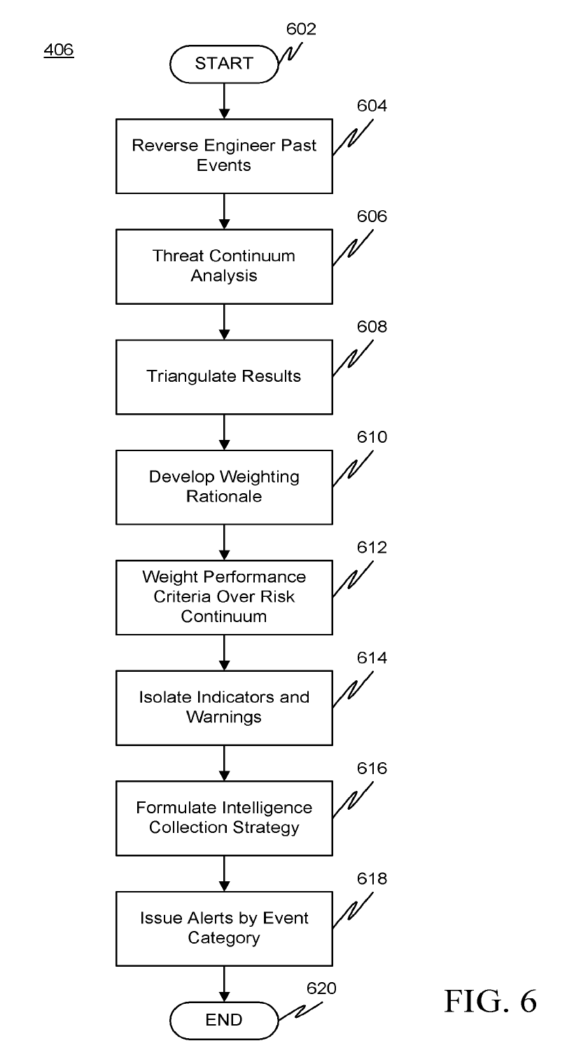

At 406, performance criteria are determined and weighted. The determination of performance criteria (or modification of predetermined criteria) can be manual (e.g., entering performance criteria specific to a given organization into a database) or automatic (e.g., using previously established performance criteria for an industry or sector of activity to automatically generate a baseline set of performance criteria that are likely to cover most if not all of the performance criteria for an organization in that industry or sector). Further details of 406 are described below in connection with FIG. 6 and FIG. 21. Processing continues to 408.

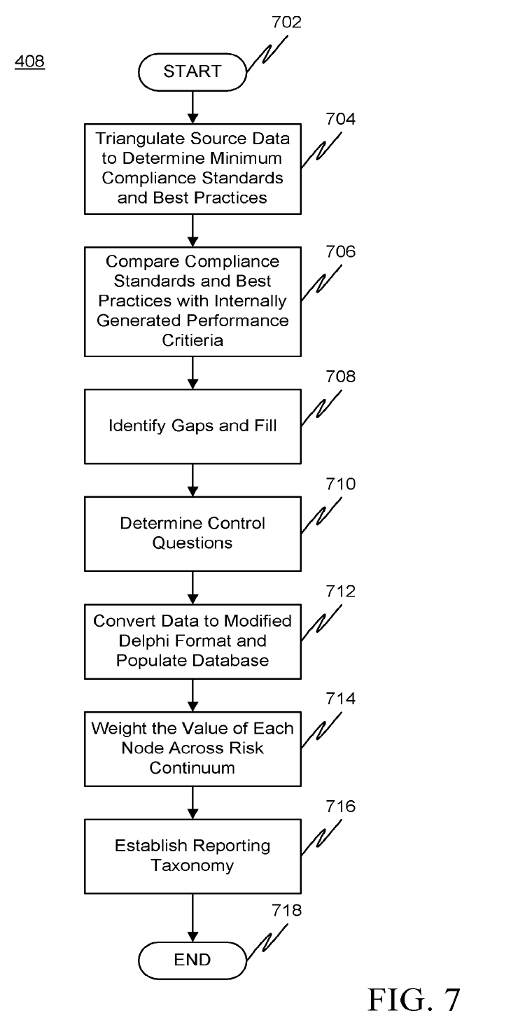

At 408, a standards library is constructed automatically, manually or through a combination of manual and automatic techniques (as discussed above regarding knowledge engine 202). The standards library can be in the form of an electronic (or computerized) database. The standards can include: federal, state and/or local rules, regulations, statutes and the like; local and/or national codes; national standards (e.g., ANSI); best industry practices; policies, procedures and processes internal to an organization, entity or facility; good manufacturing practices; and/or the like. Further details of 408 are described below in connection with FIG. 7. Processing continues to 410.

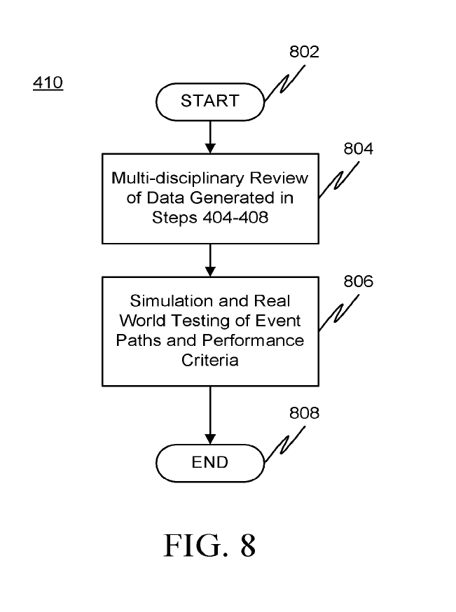

At 410, the performance criteria are validated and tested. The validation and testing of performance criteria may include actual human testing of performance criteria and assumptions. A particular approach to deterring, detecting, preventing, responding to or mitigating an event can be validated with human simulation and testing and the performance criteria can be refined. Further details of 410 are described below in connection with FIG. 8. Processing continues to 412.

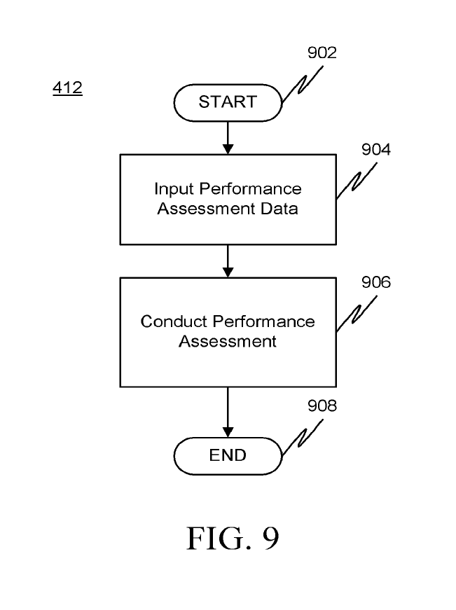

At 412, a client is assessed based on the performance criteria determined and validated in 406 and 410, respectively. The assessment is used to convey to a client organization how well the organization is performing with respect to specific performance criteria. For example, an organization may be underperforming in a first performance criterion that is critical, while over performing in a second performance criterion that is less critical than the first. Such information can be used by an organization to reallocate resources according to the assessment, say by allocating more resources to the first performance criterion and less resource to the second performance criterion in the example mentioned above. Further details of 412 are described below in connection with FIG. 9. Processing continues to 414.

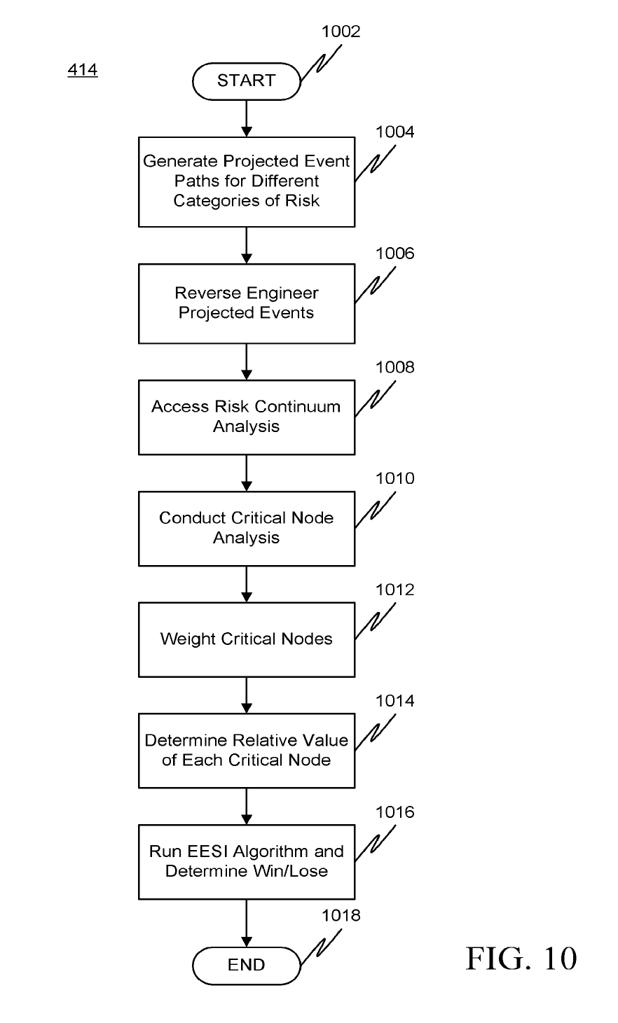

At 414, future events are projected. The projection of future events encompasses a collection of techniques designed to produce a projected range of possible events, rather than trying to predict an event or a step within an event or situation. Further details of 414 are described below in connection with FIG. 10. Also, future event projection is discussed in further detail in reference to FIGS. 18-24. Processing continues to 416.

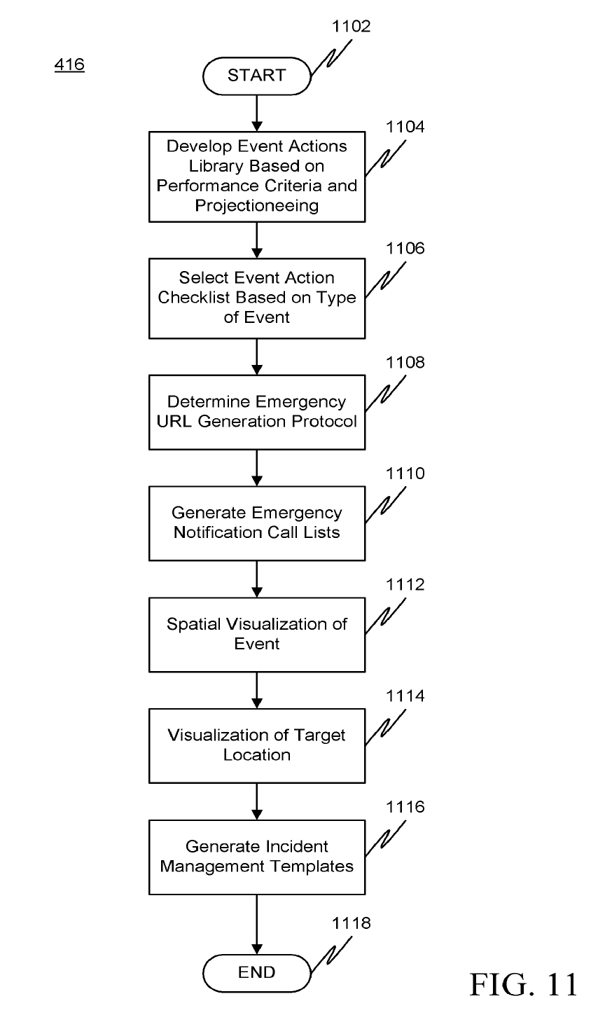

At 416, event management is performed. Event management encompasses providing response templates for an event and contacting the appropriate parties to alert them to the event. Additional details of 416 are described below in connection with FIG. 11 and in connection with FIGS. 30-34. Processing continues to 418.

At 418, one or more steps are repeated based on the complex risk event or threat situation being assessed and controlled. Processing continues to 420, where processing ends.

FIG. 5 is a chart showing further detail of the method 404 of triangulating and weighting risk event categories in accordance with the present disclosure. Processing begins at 502 and continues to 504.

At 504, available data is triangulated, as discussed above in relation to triangulate and weight relevant categories 404. Processing continues to 506.

At 506, an events database is designed and populated. The events database can be built and populated according to the techniques and structure set forth in co-pending application entitled “Metadata Database System and Method,” by the same inventor as the present application and filed on Nov. 17, 2010, which is hereby incorporated herein by reference in its entirety. Processing continues to 508 where the categories of risk events are triangulated as discussed above. Processing continues to 510.

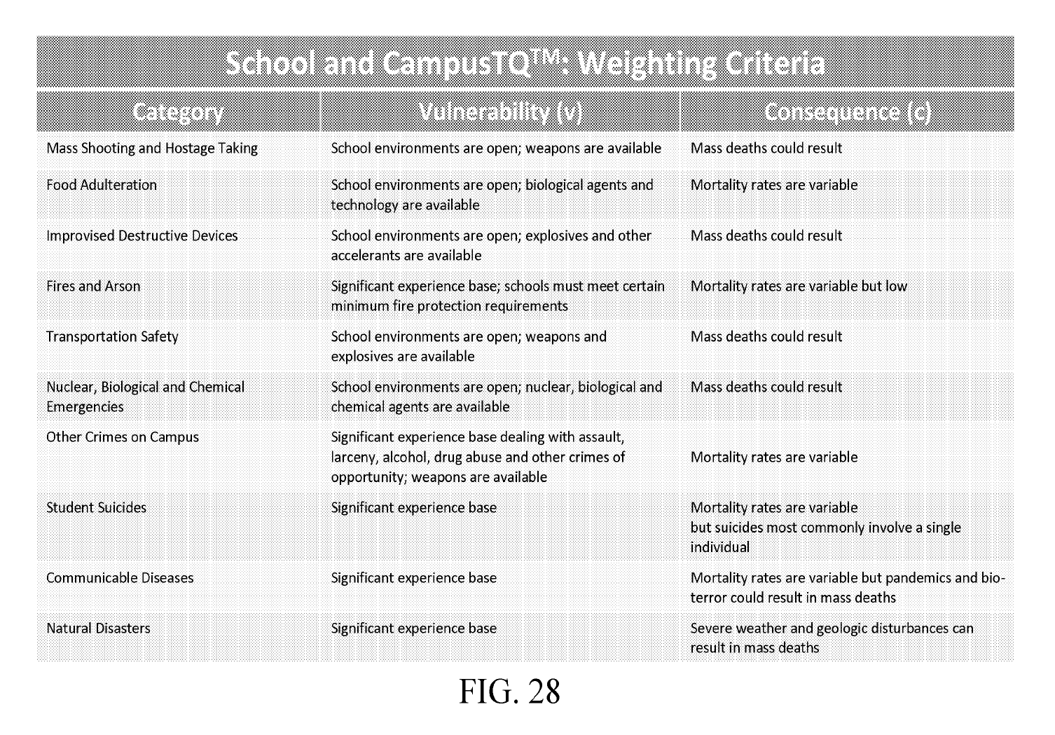

At 510, weighting criteria for each risk event category is determined. The process of determining weighting criteria is discussed in greater detail below in reference to FIG. 28. Processing continues to 512.

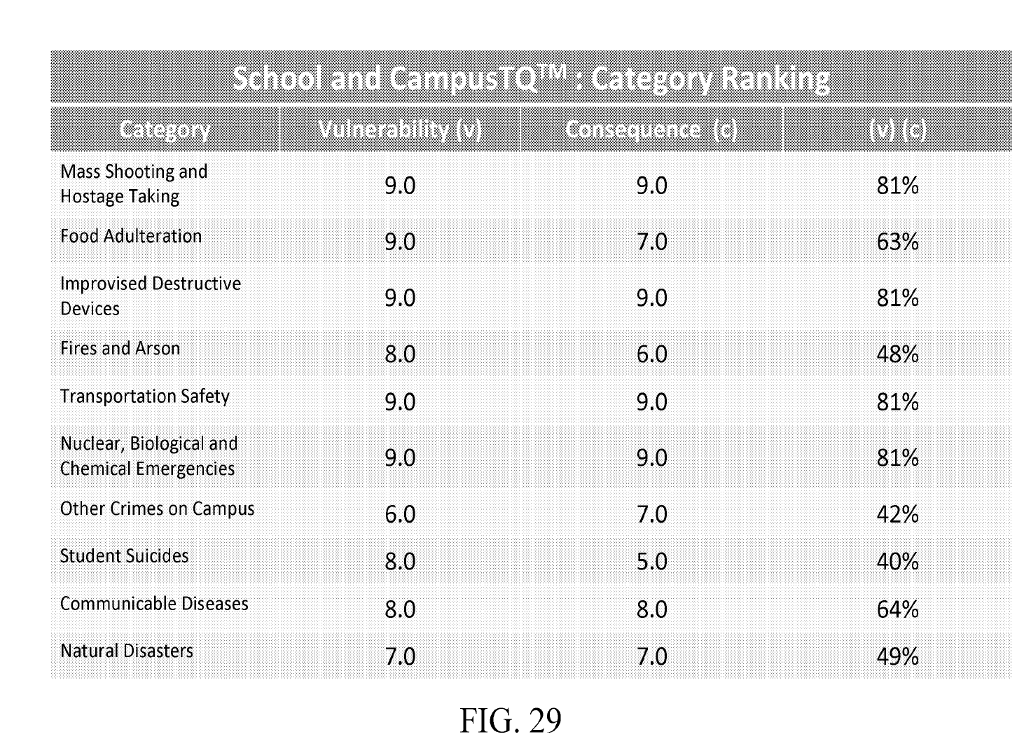

At 512, each risk event category is weighted and ranked. The weighting and ranking of risk event categories is discussed in greater detail below in reference to FIG. 29. Processing continues to 514, where processing ends.

FIG. 6 is a chart showing details of the method 406 of determining and weighting performance criteria in accordance with the present disclosure. Processing begins at 602 and continues to 604.

At 604, past events are reverse engineered. The process of reverse engineering past events can include generating an event path sequence by deconstructing an event into the steps leading up to and including the event and also identifying the results or aftermath of the event. Each step and consequence in the event path can be placed into a database record associated with that event. Processing continues to 606.

At 606, a threat (or risk) continuum analysis is performed based on a threat continuum including phases of: deterring, detecting, preventing, responding and mitigating. Deter and detection fall under a surveillance functional area. Detect and prevent fall under a communication area. Prevent and respond fall under a timeliness of response grouping and all phases on the threat continuum can be correlated with the quality of the response. Processing continues to 608.

At 608, performance criteria are determined in conjunction with historical data and organization procedures and personnel. An example of performance criteria is shown in FIG. 27. Processing continues to 610.

At 610, a rationale for weighting performance criteria over the threat (or risk) continuum is developed using historical data from a database and/or data from the organization. An example of a performance criteria weighting rationale is discussed below in reference to FIG. 28. Processing continues to 612.

At 612, performance criteria are weighted over the threat continuum according to the rationale developed in 610. Performance criteria may have different impact at different stages of the threat continuum. For example, a metal detector at an entrance door may serve to deter, detect or prevent a shooting incident, but may do little to respond to or mitigate such an event. Accordingly, the performance criterion of placing metal detectors at entrance doors may be weighted more heavily for deterring, detecting and preventing relative to the weighting for responding to and mitigating. An example of performance criteria weighting is discussed below in connection with FIG. 29. Processing continues to 614.

At 614, indicators and warnings are isolated. Indicators and warnings are identified and isolated based on past event data. Indicators and warnings are those things that, had we known them in advance, an event could have been stopped or interrupted. For example, in the analysis of a building shooting incident, the indication of a metal object on person may have been effective in stopping the incident from happening, and thus a metal detector would be an indicator. In another example, it is known that many, if not all, student shooting suspects mentioned the thought of harming others to at least one adult prior to taking action. Thus, the mentioning of a violent action by a student, had it been followed up on appropriately, may have been effective to preventing a school shooting incident. Processing continues to 616.

At 616, an intelligence collection strategy is formulated. The intelligence collection strategy can be formulated automatically (e.g., using past event path and critical node analysis data), manually (e.g., with the input of organization personnel and/or outside experts) or through a combination of the above. The intelligence collection strategy can include identifying what data is needed order to issue alerts, for example, door alarm monitors. Processing continues to 618.

At 618, alerts by event category are issued by the system. The indicators and warnings and the intelligence collection strategy combine to form an approach for monitoring situations and in which alerts can be issued by event category to the organization. For example, in the case of a school shooting incident, metal detectors were in use, but the emergency exit doors had no alarms. Accordingly, the perpetrators of the shooting placed weapons just outside emergency doors, entered the building through the metal detectors and then proceeded to open the emergency exit doors, retrieve their weapons and begin an attack on the school. The present system, having knowledge of this specific past event, would have issued an alert to a school for the shooting threat category if the school either didn't have metal detectors, or had metal detectors, but no alarms on emergency exit doors. In this way, the system can use knowledge of past events and of the indications and intelligence needed to thwart a similar event in the future to alert an organization to weaknesses in their current system or processes. Processing continues to step 620, where processing ends.

FIG. 7 is a chart showing further detail of a method 408 of constructing a standards library in accordance with the present disclosure. Processing begins at 702 and continues to 704.

At 704, source data is triangulated to determine minimum compliance standards and best practices. Triangulation, in the case of a standards library, can include identifying a set of categories for the standards and a minimum set of items or process steps in each category that would satisfy the various constituents of the standards library. For example, in the food processing industry, one category of standard may relate to worker health and cleanliness. Within the worker health and cleanliness category, there may be specific requirements such as having a written worker health policy. The requirement for a written worker health policy may satisfy a number of rules, regulations, industry standards, minimum compliance standards and/or best practices. Source data can be collected automatically by crawlers, robots or spiders from publicly accessible information sources such as government websites, industry or trade organizations and the like. Processing continues to 706.

At 706, compliance standards and best practices are compared with internally generated performance criteria. A result of this comparison is an identification (see 708, below) of any “gaps” between the performance criteria and compliance standards and best practices. For example, a gap would exist where even if compliance standards and best practices were applied, an event would not be stopped. Thus there is a “gap” between the compliance standards and best practices and the performance criteria for a given event. Processing continues to 708.

At 708, any gaps in the compliance standards and best practices are identified and filled. A gap can be filled by including a process step or structural element that would stop the event. For instance, referring back to the earlier school shooting example, a best practice was to use metal detectors at entrance doors to a school. However, there was a gap between the best practice and the performance criteria in that the emergency doors did not have alarms and allowed weapons to be stashed outside those doors and retrieved without alerting school officials. Thus, the gap between the performance criteria and best practices could be “filled” by specifying that emergency doors have alarms installed. Processing continues to 710.

At 710, control questions are determined. Control questions are used to validate that the answers to earlier questions are accurate. For example, a question about a specific written policy may be followed by a control question asking about the contents of the written policy. Or, a question about compliance with a standard may be followed by a control questions asking a specific detail of the standard that, if answered correctly, would suggest that indeed the organization was in compliance with the standard. Control questions are used to help verify the proper survey responses. Processing continues to 712.

At 712, data is converted to a modified Delphi format and stored in a database. The triangulated standards information determined earlier is converted to question format for use in a survey. For example, if it was determined that having a written worker health policy was a triangulated data point in the standards for food processors, that data point could be turned into a question by phrasing it as “Do you have a written worker health policy?” Modified Delphi format is used in the Delphi forecasting method based on the results of automatically generated online survey questionnaires sent to a panel of experts (or organization personnel). For example, one or more rounds of questionnaires can be sent out, and the anonymous responses can be aggregated and shared with the group after each round. Survey participants can be allowed to adjust their answers in subsequent rounds. Because multiple rounds of questions can be asked and because each member of the panel may be told what the group thinks as a whole, the Delphi Method seeks to reach the “correct” response through consensus. The control questions could be used in a subsequent surveying round of questionnaires. Processing continues to 714, where processing ends.

FIG. 8 is a chart showing further detail of a method 410 of validating and testing performance criteria in accordance with the present disclosure. Processing begins at 802 and continues to 804.

At 804, a multi-disciplinary review is performed on the data generated in steps 404-408 of FIG. 4, described above. The multi-disciplinary review can include evaluating the past events database, the performance criteria and the standards library from the vantage point of various disciplines, e.g., manufacturing, police/security, fire fighting, medical, operations, administration, financial, facilities, physical plant and/or the like. The multi-disciplinary review helps to ensure that the data generated in steps 404-408 are accurate and complete to an appropriate level. Processing continues to 806.

At 806, event paths and performance criteria are tested using simulations and real-world testing. Performance criteria during past events and projected events can be tested and simulated to fully consider whether the right performance criteria have been identified for each category of event. For example, an early approach to a shooter in a school setting was for the instructor to place a piece of red paper in a window to indicate to police or other emergency personnel that the shooter was or had been in that room. However, during simulations of a school shooting event it became apparent that the teacher would be exposed to increased danger along with the class when the “paper in the window” technique was attempted. Instead, with input from military tactical experts, it was determined that the best course of action (e.g., least casualties) was for everyone in the classroom to flee. By testing performance criteria in simulated real-world settings, the accuracy of the information that will be automatically generated can be improved. Essentially, steps 804 and 806 provide a real-world human check on the data at this stage and can correct or improve the data as needed. Processing continues to step 808, where processing ends.

FIG. 9 is a chart showing further detail of a method 412 of client assessment in accordance with the present disclosure. Processing begins at 902 and continues to 904.

At 904, performance assessment data is received by the system. The performance assessment data can be collected and received from automated online surveys having questions generated as discussed above. Processing continues to 906.

At 906, a performance assessment is conducted. The performance assessment can include comparing the gathered performance data of an organization with the expected performance data based on past event analysis. Difference between actual and expected performance can indicate an under (or over) performance that needs correcting. The performance assessment can be output as a report or as a graphical visualization such as that shown in FIGS. 14-16. Processing continues to 908, where processing ends.

FIG. 10 is a chart showing further details of a method 414 of projecting future events, in accordance with the present disclosure. Processing begins at 1002 and continues to 1004.

At 1004, projected event paths for different categories of risk are generated. These projected event paths are generated based on actual past events taken from the past events database or from contemplated possible events. Processing continues to 1006.

At 1006, projected events are reverse engineered. Reverse engineering, as described above, includes breaking down an event into its constituent steps, critical nodes and results.

Processing continues to 1008. At 1008, a risk continuum analysis is accessed. The risk continuum analysis includes an analysis of each projected event path along the threat (or risk) continuum. For example, see FIG. 21 and related description below. Processing continues to 1010.

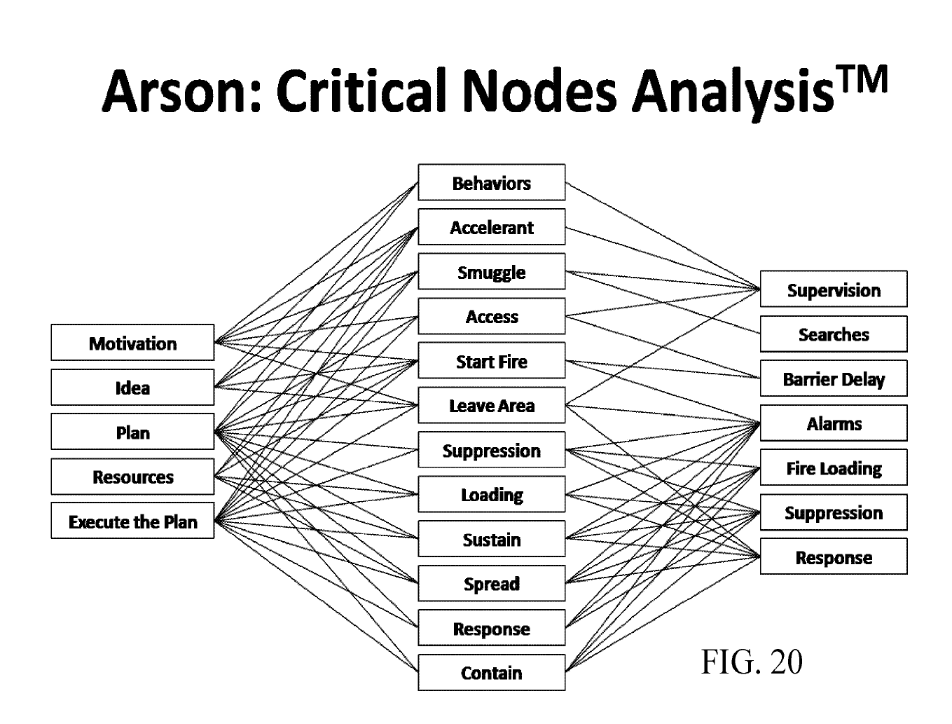

At 1010, a critical node analysis is performed. Critical nodes are analyzed along the threat continuum. Critical nodes are analyzed because they can play a role in deterring, detecting, preventing, responding to and/or mitigating a risk event. Critical node analysis can include analyzing an event path to determine what actions or information along the event path could have stopped, interrupted or impeded progression of the event. See, also description of FIGS. 20 and 21, below. Processing continues to 1012.

At 1012, critical nodes are weighted. The weighting of critical nodes along the threat continuum can be performed automatically and/or manually. For example, relative weighting of critical nodes from past events of the same or similar category could be used to automatically determine a critical node weighting. The critical node weighting could also be determined using a manual input method or a manual adjustment of an automatic input method. Processing continues to 1014.

At 1014, a relative value of each critical node is determined. The relative value of critical nodes according to relative importance can be performed automatically and/or manually. For example, relative weighting of critical nodes from past events of the same or similar category could be used to automatically determine a critical node weighting. The critical node weighting could also be determined using a manual input method or a manual adjustment of an automatic input method. Processing continues to 1016.

At 1016, an estimated event sequence interruption (EESI) value is calculated and a win/lose determination is automatically generated based on the performance criteria values and the critical node weight and relative importance. The EESI value is calculated based on the following formula:

I f (dnₜ)(cₜ)(dyₜ)(rₜ)(r_{q}).

Where dnₜ represents a time of detection, cₜ represents time to communicate a response action, dyₜ represents a delay time, rₜ represents a time to respond and r_{q} represents a quality of response.

Processing continues to 1018, where processing ends.

FIG. 11 is a chart showing further detail of a method 416 of event management or response control in accordance with the present disclosure. Processing begins at 1102 and continues to 1104.

At 1104, an event actions library is developed based on performance criteria and projected events. The event actions checklist can be automatically generated and can include checklists for each category of risk or threat event. For example, FIG. 30 shows an event actions checklist. Processing continues to 1106.

At 1106, an event action checklist is selected based on the type of event. As mentioned above, the event actions library can include an event action checklist for each event category (and/or specific event). Based on received user inputs, the system can automatically retrieve and present the event action checklist for a particular event in progress. Processing continues to 1108.

At 1108, an emergency URL generation protocol is determined. The emergency URL generation protocol is a procedure use to generate a random URL for emergency use during the event. The emergency URL can point to an online resource page that provides information to organization personnel and first responders, emergency workers and/or police, security or military forces. Processing continues to 1110.

At 1110, emergency notification call lists are generated. Emergency notification call lists are generated based on the specific event and include generating a list of those people or organizations that have previously been entered in to the data and associated with the event category or specific event. The call list can be provided as output to a person or another system, or the call list can be automatically processed and calls, emails, text message and/or the like can be sent to entities on the call list. Processing continues to 1112.

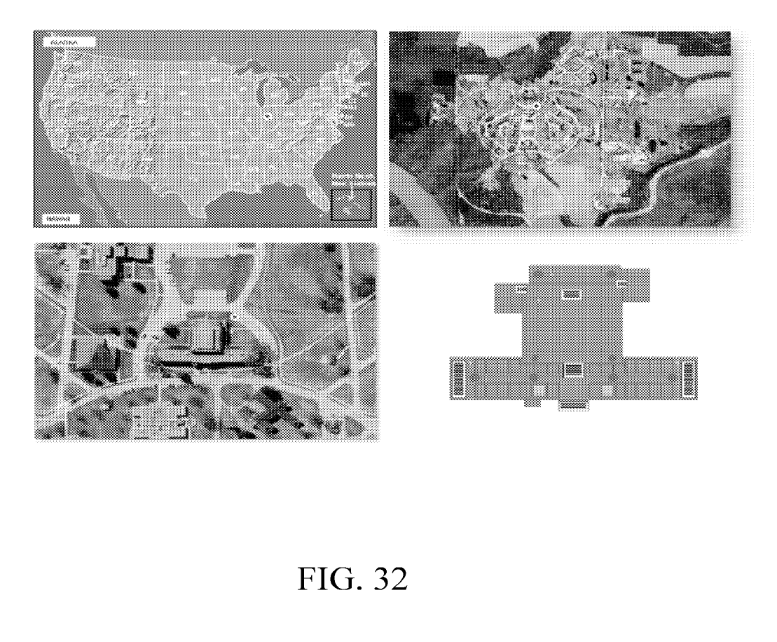

At 1112, a spatial visualization of an event is generated. The spatial visualization may be viewed on a display device coupled to a risk management system or transmitted to another system (such as another workstation, a PDA, wireless device or the like) for viewing. The spatial visualization can be generated using, for example, electronic mapping software. See, for example, FIG. 32. Processing continues to 1114.

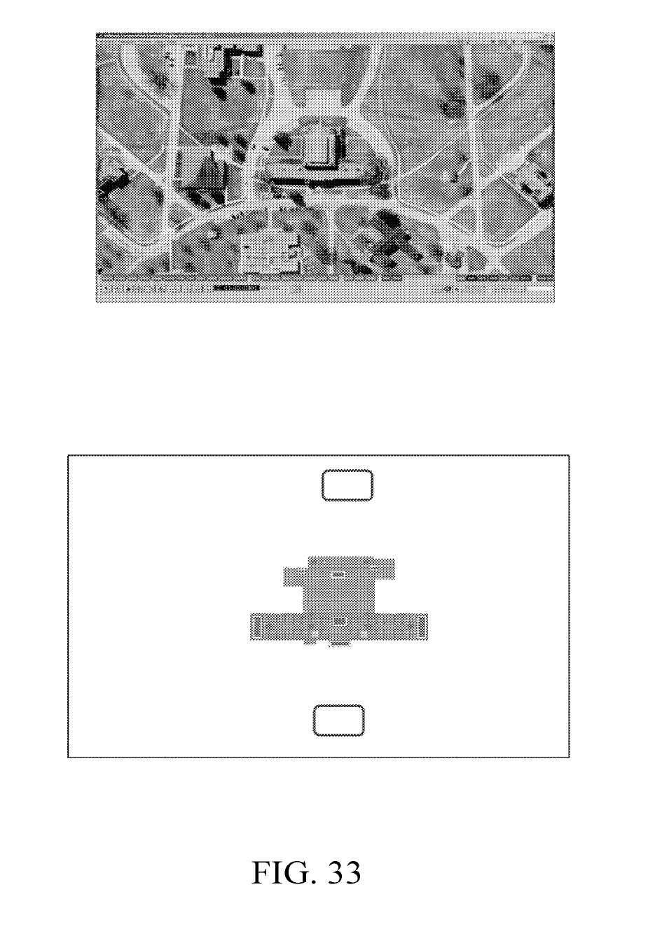

At 1114, a target location is shown on the spatial visualization. Based on input by organization personnel, emergency or security workers, a target location can be specified and displayed on the visualization. See, for example, FIG. 33. Processing continues to 1116.

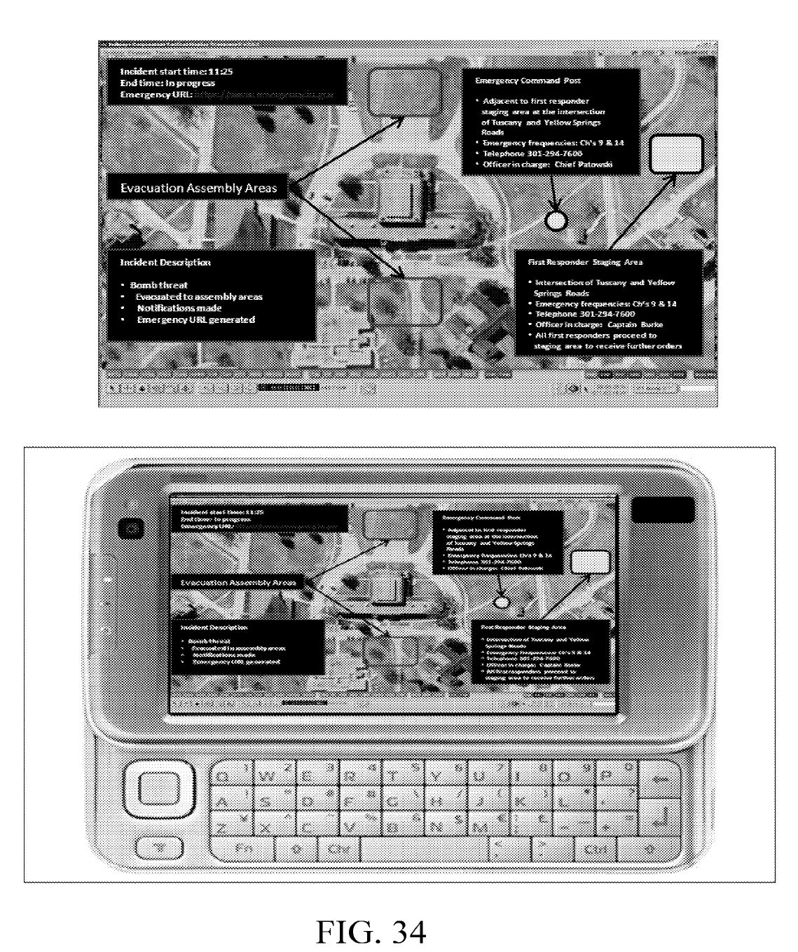

At 1116, incident management templates are generated. Incident management templates are generated from a combination of an existing incident template retrieved from the database along with event specific information received about the event in progress. An incident management template can include a graphical rendering of the area of the incident along with incident start/end times, incident description, emergency URL, identification of evacuation assembly areas, emergency command post and first responder staging areas. See, FIG. 34 for more detail. Processing continues to 1118, where processing ends.

FIG. 12 is a diagram of a computer system for event assessment, projection and response control in accordance with the present disclosure. The event analysis and response system 102 includes a processor 1202 having a processing unit 1203 and a computer readable memory 1205. The processor 1202 is connecting to a database 1204, a display 1206, one or more I/O devices 1208, one or more sensors 1210 and one or more actuators 1212. The processor is also connected to a network 1214 (e.g., a LAN, WAN, WiFi, Internet, or the like). The processor 1202 is able to receive data from external information sources 1218 and to exchange information with other devices such as a wireless device 1216.

The display 1206 can include a CRT, LCD, LED, plasma display or the like. The I/O devices 1208 can include a keyboard, mouse, pointer or the like. The sensors 1210 can include sensors such as video, audio, temperature, chemical, biological, nuclear sensors, and also threat scanning equipment (metal detector, x-ray, millimeter wave or the like). The actuators 1212 can include solenoids, relays, signal lines to other systems, and also auditory or visual indicators.

As a user moves through various user interface screens shown on display 1206 for entering data and/or viewing reports or visualizations, the user can select a user interface element on each screen that will capture a “snapshot” of the screen (either to a data storage device as a digital file or to a print out, or both). A sequence of snapshots can be used, for example, as back-up information for a risk analysis or assessment and as documentation of the process steps and values entered/reviewed at each point in the analysis or assessment.

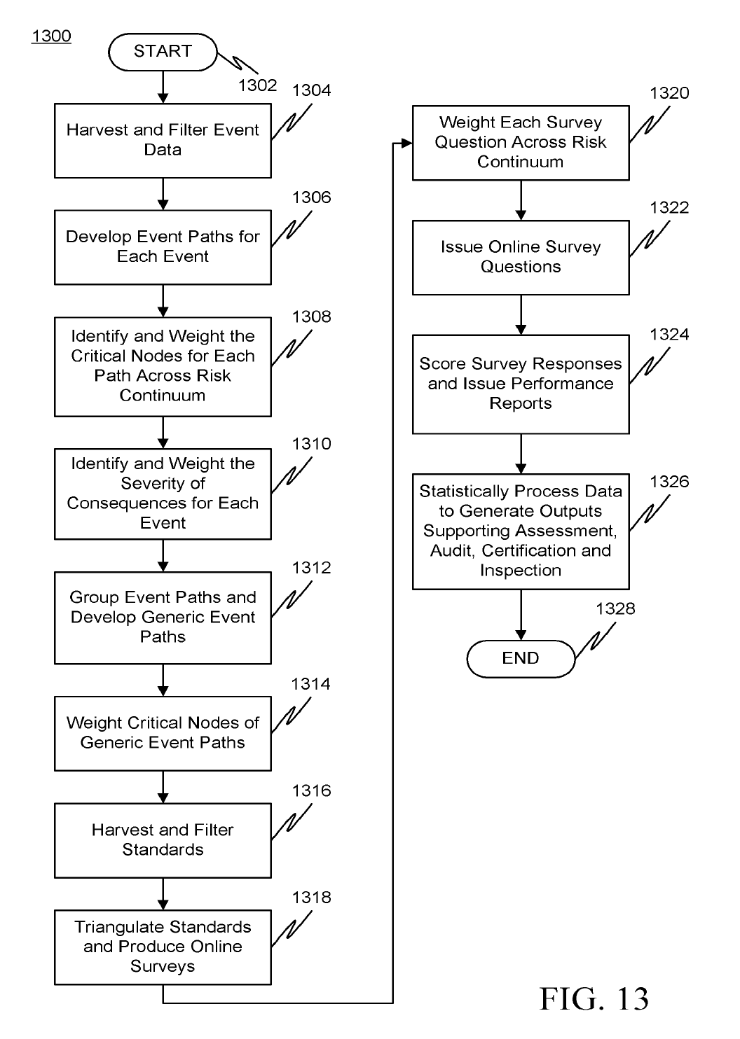

FIG. 13 is a chart showing a method 1300 for computerized event assessment, projection and control in accordance with the present disclosure. Processing begins at 1302 and continues to 1304.

At 1304, event data is harvested and filtered. For example, event data can be harvested from sources on the Internet using a spider, bot or crawler to automatically access a web page and retrieve information. The retrieved information can be filtered so that only the information of interest is retained. The harvested and filtered event data can be stored in a database. Processing continues to 1306.

At 1306, event paths (e.g., as discussed above in connection with 604 of FIG. 6) are developed for each event. Processing continues to 1308. At 1308, the critical nodes for each event path are identified and weighted across the risk (or threat) continuum. Processing continues to 1310.

At 1310, the severity of the consequences for each event are identified and weighted. By identifying and weighting the severity of event consequences, an organization or entity can determine a priority list of events based on consequence severity. See, e.g., FIGS. 28 and 29 and accompanying descriptions below for further discussion of consequence weighting. Processing continues to 1312. At 1312, event paths are grouped and generic event paths are developed. Processing continues to 1314.

At 1314, critical nodes of generic event paths are weighted. The critical nodes are weighted along the threat (or risk) continuum in order to perform an analysis of which critical nodes can have the most effect on a particular phase of the threat continuum. Processing continues to 1316. At 1316, standards are harvested and filtered. Standards may be harvested and filtered in a manner similar to that described above regarding 1304 and 408. Processing continues to 1318.

At 1318, standards are triangulated and online surveys are produced. Processing continues to 1320. As discussed herein, triangulating standards to generate a set of online survey questions can include identifying a set of questions that covers each of the relevant standards at a level, such as minimum compliance, best practice, and/or good manufacturing, or the like. A minimum set of questions may be generated that can be used to assess the appropriate standards with a minimum number of survey questions. At 1320, each survey question is weighted across the risk (or threat) continuum. For example, questions relating to preventative measures (e.g., worker health) may be more heavily weighted on the prevent phase of the threat continuum as opposed to the response phase. Processing continues to 1322.

At 1322, online survey questions are issued electronically, for example, via email, web page, mobile device application or the like. Processing continues to 1324. At 1324, survey responses are scored and performance reports are generated and issued. The survey responses can be used to generate a numerical score that represents a measure of how well an organization or entity is meeting standards for minimum compliance, best practices, good manufacturing practices, or the like. Processing continues to 1326.

At 1326, data is statistically processed to generate outputs supporting assessment, audit, certification and inspection. For example, the performance criteria weighting and ranking can be compared against the survey results corresponding to those same performance criteria to determine how well an organization or entity is meeting the applicable standards. Processing continues to 1328, where processing ends.

It will be appreciated that, for the above-described processes, steps may be repeated in whole or in part in order to accomplish a contemplated risk management task.

FIG. 14 shows an exemplary dashboard-style display 1400 in accordance with the present disclosure. In particular, the dashboard-style display 1400 can include one or more graphical gauges 1402 that indicate the performance for a given criteria (e.g., core safety program, fire safety, etc.). A legend 1404 can be provided on the display that tells a user what the gauge value ranges indicate (e.g., immediate attention required, does not meet expectations, and best practice). This type of display can be used to indicate performance criteria analysis results, threat assessment, critical node analysis results, or, in general, any values that may be suitable for display in a dashboard-style.

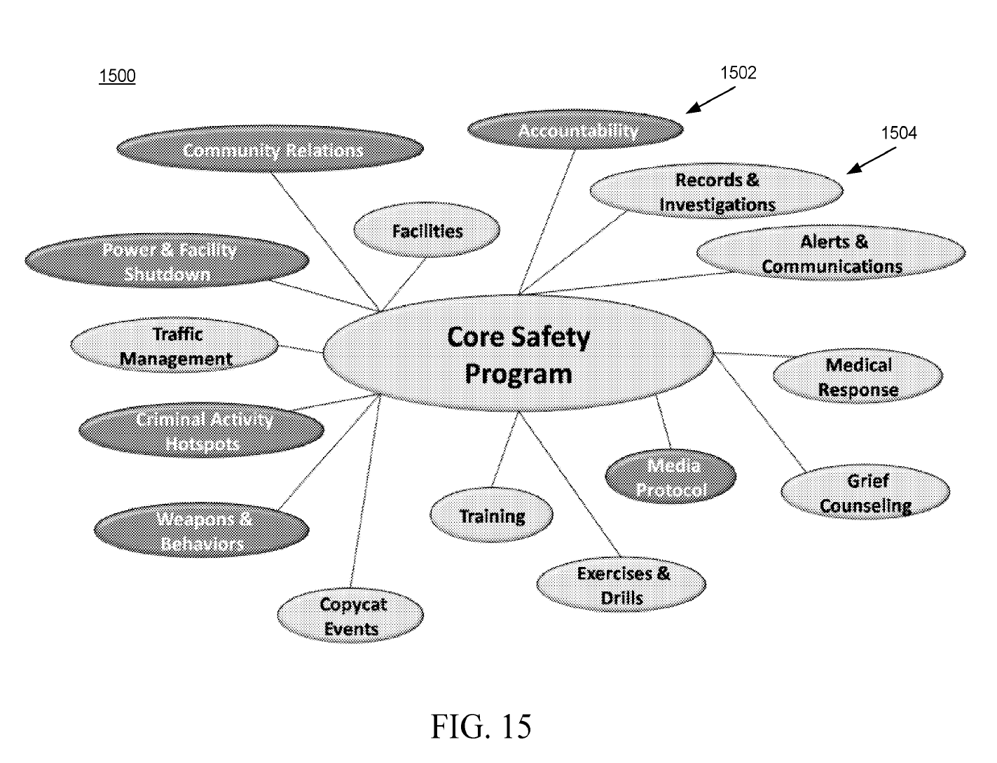

FIG. 15 shows an exemplary hyperbolic map 1500 output in accordance with the present disclosure. The hyperbolic map 1500 includes graphical elements that can be colored, shaded or filled or sized to indicate a difference between value levels (e.g., between 1502 and 1504). This type of display can be used to indicate performance criteria analysis results, threat assessment, critical node analysis results, or, in general, any values that may be suitable for display in a hyperbolic map.

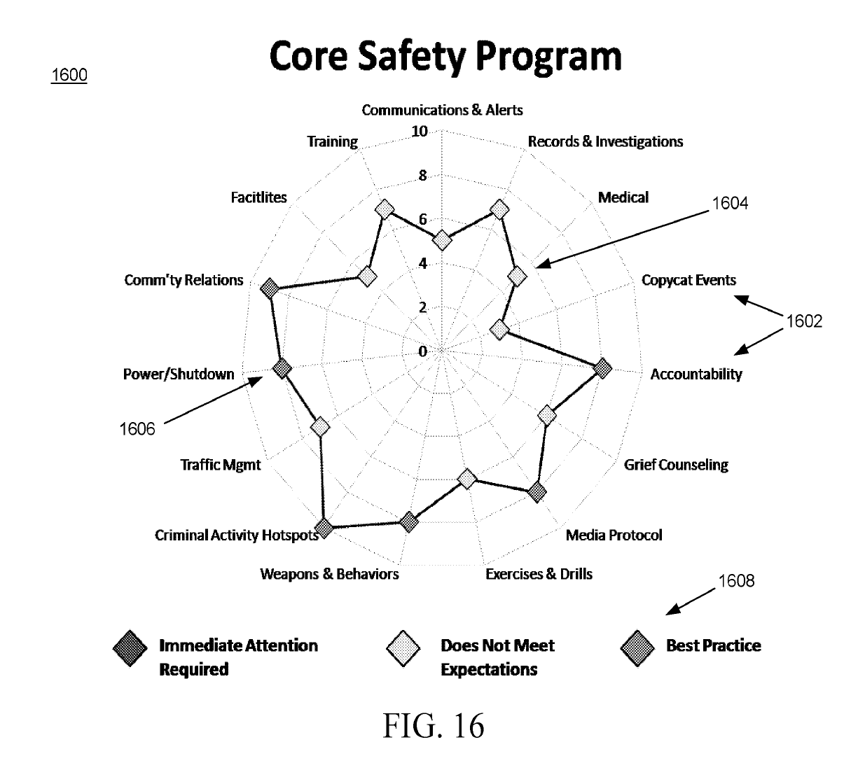

FIG. 16 shows an exemplary profile output 1600 in accordance with the present disclosure. The profile output 1600 (also known as a spider chart or radar plot) includes a number of radii each associated with an item 1602 such as a critical node, performance criteria or the like. The profile output 1600 also includes plot points (1604 and 1606) indicating a value of an individual item on the chart. The profile output can also include a legend 1608 that shows what each plot point color indicates. For example, a red plot point can be used to indicate that immediate attention is required for that individual item; a yellow point can be used to indicate that that individual does not meet expectations and a green plot point can be used to indicate that a best practice is being used for the item associated with that plot point.

FIG. 17 shows an exemplary best investment bar graph output 1700 in accordance with the present disclosure. The best investment bar graph 1700 shows individual values (1702) for each critical node (1704) at each phase along a threat continuum (1706). The best investment bar graph illustrates which threat continuum phase each critical node is most effective in, and also for a given threat continuum phase which critical node would make the best investment.

FIG. 18 is an exemplary diagram of an event path analysis 1800 in accordance with the present disclosure. The event path analysis 1800 includes a high level path 1802 and a detailed path 1804 showing the time sequence of steps that make up a typical arson event from start to finish. The high level path includes the steps of motivation, idea, plan, resources and execution. These high-level steps are common to most human initiated events.

The detailed steps 1804 include threats or threatening behavior, obtain accelerant, smuggle into building, access target area, start fire, leave area undetected, automatic suppression, fire loading, sustainable blaze, fire spread, response, containment. While FIG. 18 shows an event path analysis for an arson event, it will be understood that an event path analysis can be performed for any risk or threat event.

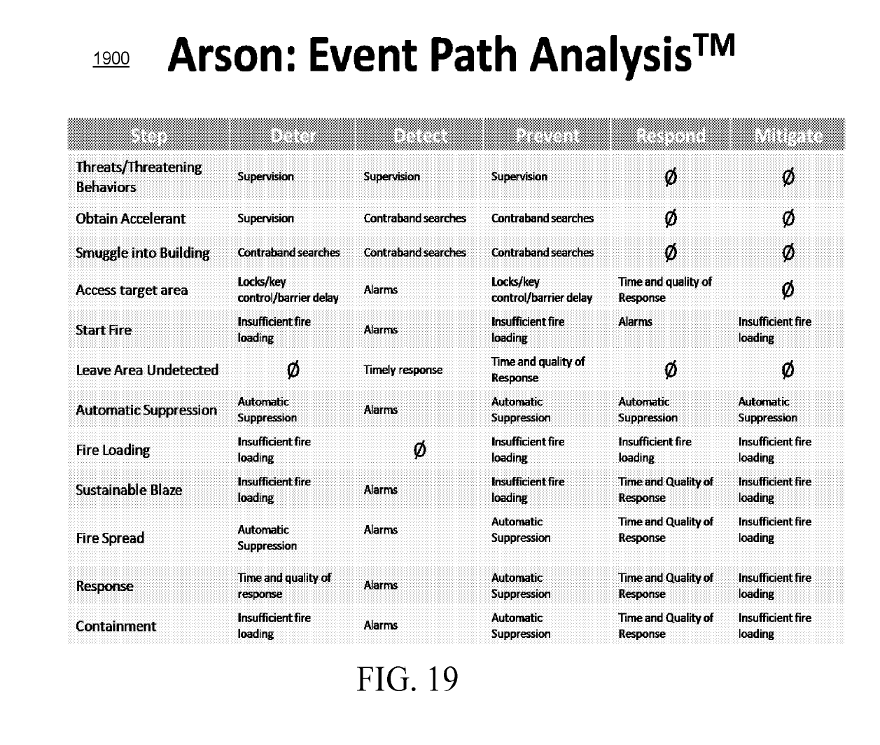

FIG. 19 is an exemplary diagram of the event path of FIG. 18 including critical nodes along a threat continuum in accordance with the present disclosure. In particular, a chart 1900 shows the arson event path detailed steps 1804 of FIG. 18 as the first column and the threat continuum (e.g., deter, detect, prevent, respond, mitigate) as the next five columns, in order. In each cell of the event path chart of FIG. 19, there is a critical node listed (if any) associated with the corresponding step/threat continuum phase. For example, for the obtaining accelerant step at the detection phase, contraband searches would be a critical node, while at the mitigation stage there is no entry because obtaining accelerant has no connection with mitigating an arson event. By connecting the event path steps with critical nodes along the threat continuum, a framework of relationships is created that will permit a quantitative analysis to be performed and output (e.g., FIG. 17).

Critical nodes can include data representing a vertex or a place where a number of interdependent variables cross one another. The critical node vertexes are those points in a larger system that may be most sensitive to changes because when they are disturbed they have the greatest extended order effects on the larger system. In other words, a critical node can represent a critical aspect of an event sequence or a category of event sequences that, when affected, can increase or decrease the likelihood of the event occurring or the consequences of event escalation. Event escalation can include a cascading system failure. Critical nodes can also include a weighting of each critical node across a threat or risk continuum. The threat (or risk) continuum can include deter, detect, prevent, respond and mitigate phases.

FIG. 20 is a diagram of a critical node analysis for the exemplary arson event path of FIGS. 18 and 19, showing a frequency analysis of the relationships between the high level event path 1802 of FIG. 18, the detailed event path 1804 of FIG. 18 and the critical nodes (see, e.g., FIG. 19). The frequency analysis can also contribute to the quantitative analysis of an event path.

FIG. 21 is a chart showing an exemplary critical node analysis chart 2100 in accordance with the present disclosure. The chart 2100 incorporates quantitative values representing the critical node/event path analysis of FIG. 19 and the frequency analysis of FIG. 20 into a single quantitative analysis chart. The critical nodes 2102 form the first column, the threat continuum values and relative weightings 2104 form the next five columns, followed by a weighted sum 2106, a normalized value 2108, a frequency 2110 and a normalized weighted value 2112 in the subsequent four columns.

The weightings of the threat continuum columns are 0.1, 0.2, 0.3, 0.25 and 0.15 for deter, detect, prevent, respond and mitigate, respectively. As can be seen from these weightings, prevention is given the highest weighting. As the example shown is for an arson event, it can be easily understand that preventing an arson event would be paramount for helping ensure human safety and property.

A best investment chart can be generated from FIG. 19 using the critical node analysis data of the chart 2100. For each critical node, the bar value can be obtained by multiplying the threat continuum phase weighting value by the critical node value to obtain a weighted critical node value than can then be normalized for graphing purposes. For example, the values 2104 of FIG. 21 can be plotted on a bar graph for each threat continuum phase of each critical node to generate a best investment chart showing the best investment by critical node and by threat continuum phase.

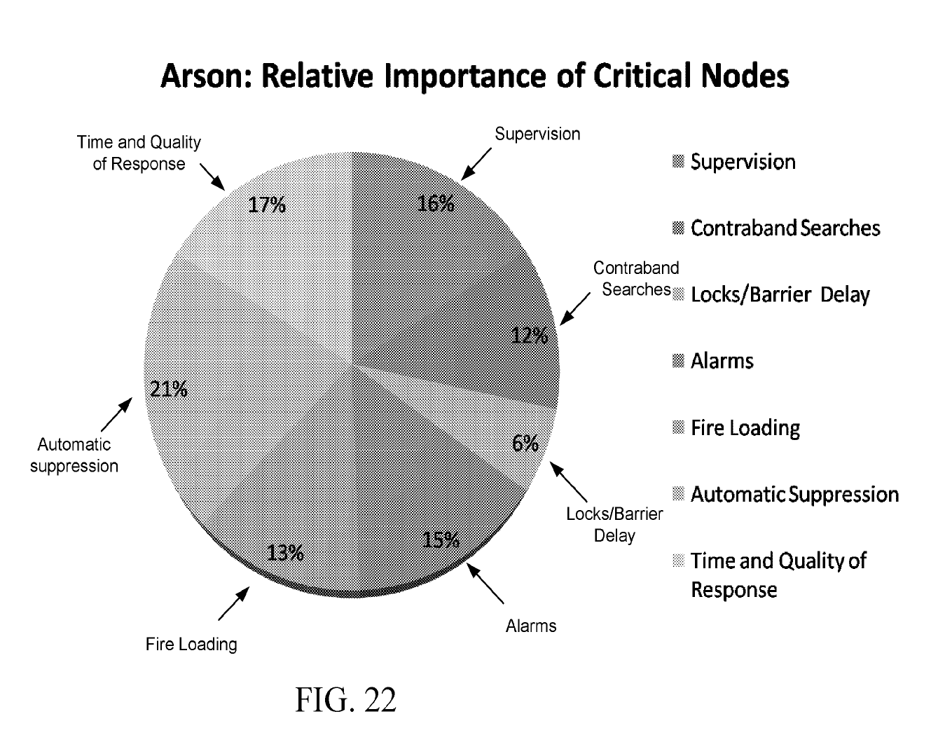

FIG. 22 is a chart showing an exemplary relative importance among the values 2112 for the critical nodes 2102 of FIG. 21. These values represent a similar indication as the best investment bar graph discussed above, except that these relative importance values represent composite numbers made up of a critical node's values across all phases or stages of the threat continuum.

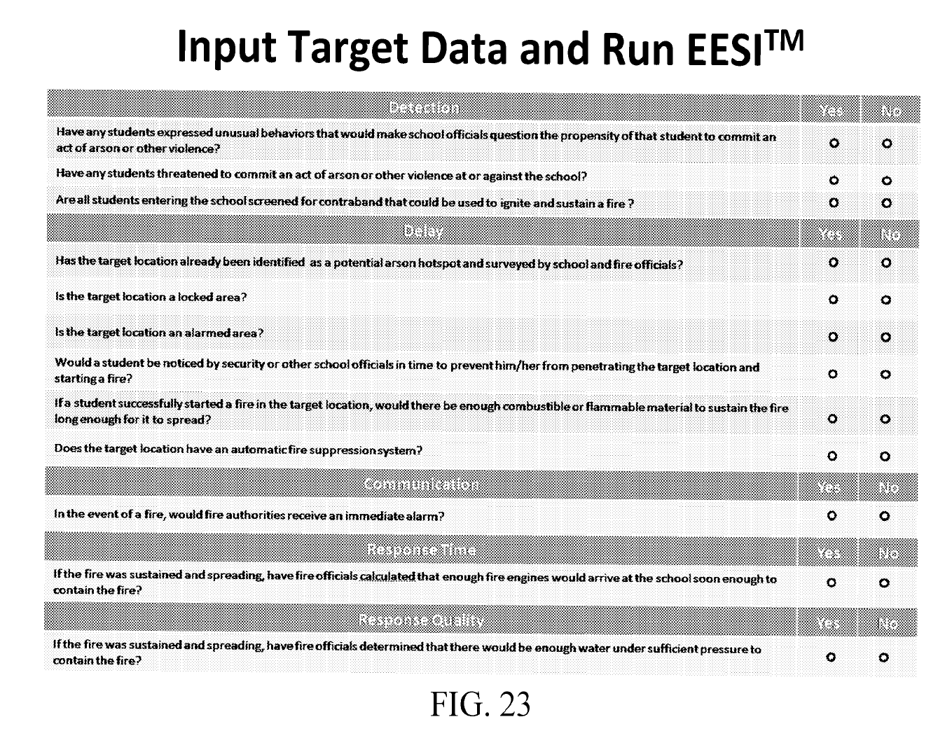

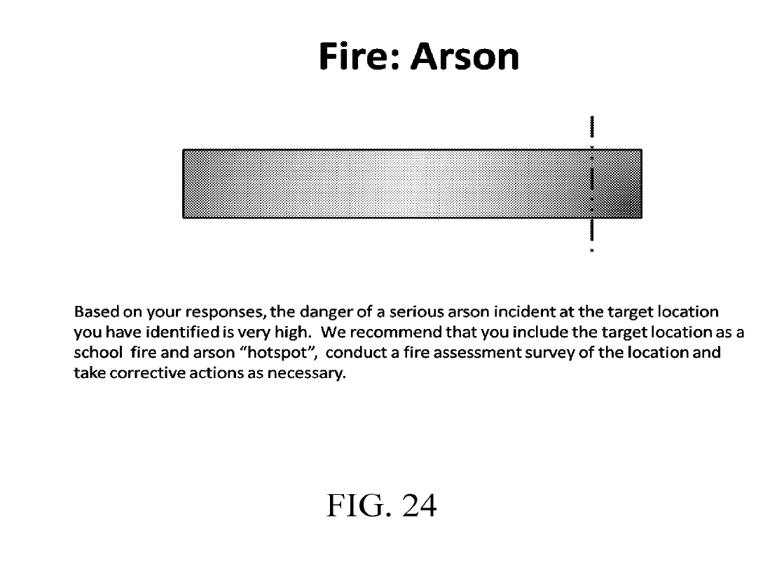

FIG. 23 is an exemplary online survey for gathering facility data in accordance with the present disclosure. These questions are formulated to assess the critical nodes that are most important to each phase of the threat continuum. The answers to these questions can be combined with the critical node analysis quantitative data to produce an output (see, FIG. 24) showing an estimated likelihood of an arson event. The combination could include assigning a point value to each positive response and then scoring the answers to come up with a total score and showing a line on the “win/lose” graph of FIG. 24 to indicate the score achieved by the organization. A high score may indicate a low likelihood, while a low score may indicate a high likelihood of the event occurring. This final output is based on quantitative values related to the event path, the threat continuum, the critical nodes and the organizations responses to an online survey questionnaire. So, the risk level of an event like arson, which is human initiated and may in the past been thought of as difficult to quantify, has, through application of the methods and system disclosed herein, been transformed into quantifiable risk level value. Moreover, a best investment bar graph output (similar to that shown in FIG. 19) can be generated that can serve to guide an organization's leadership into placing investment where it will have the greatest impact on reducing the risk of an event for any desired phase along the threat continuum.

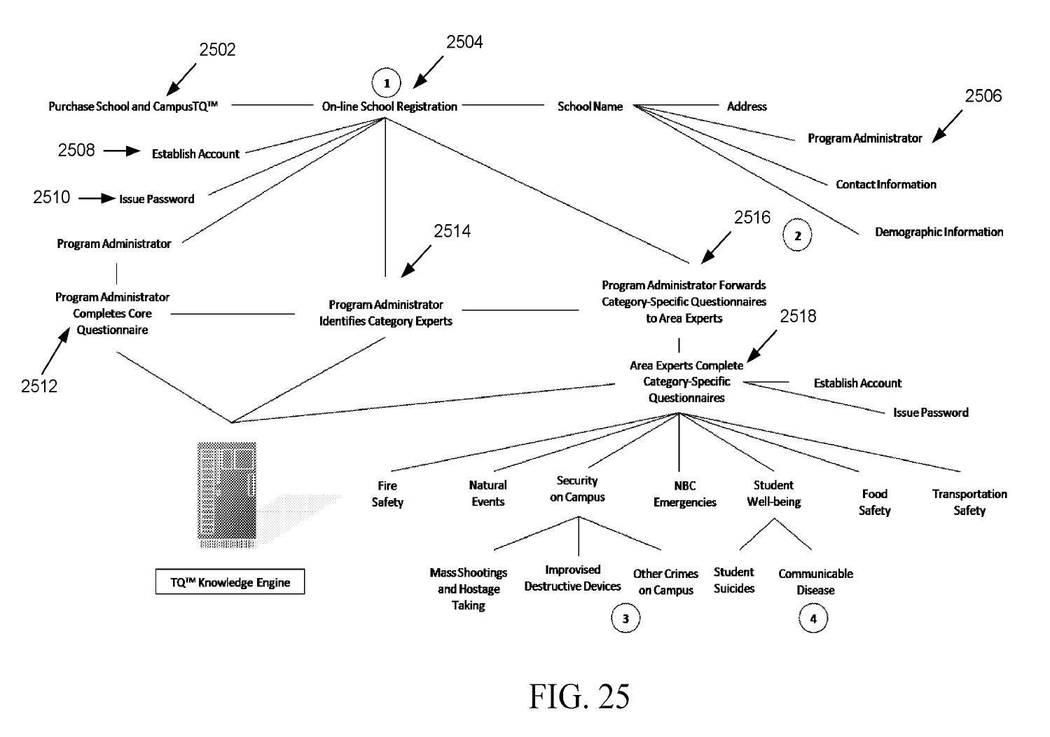

FIG. 25 is a diagram of an exemplary process for threat assessment, projection and response for a facility, for example, a school. The process begins when the school purchases a commercial embodiment of a system 2502 that has been tailored for use by schools. The school then registers the product online 2504 including providing school name, address, program administrator, contact information and demographic information 2506. This information can be used for emergency contact and for spatial visualization tasks during an event.

The school then establishes an account 2508, issues passwords 2510 and the program administrator completes the core questionnaire 2512, the results of which are stored in the knowledge engine 2513. The program administrator identifies category experts 2514 and forwards category-specific questionnaires to area experts 2516. Area experts establish accounts, issue passwords and answer category-specific questionnaires 2518.

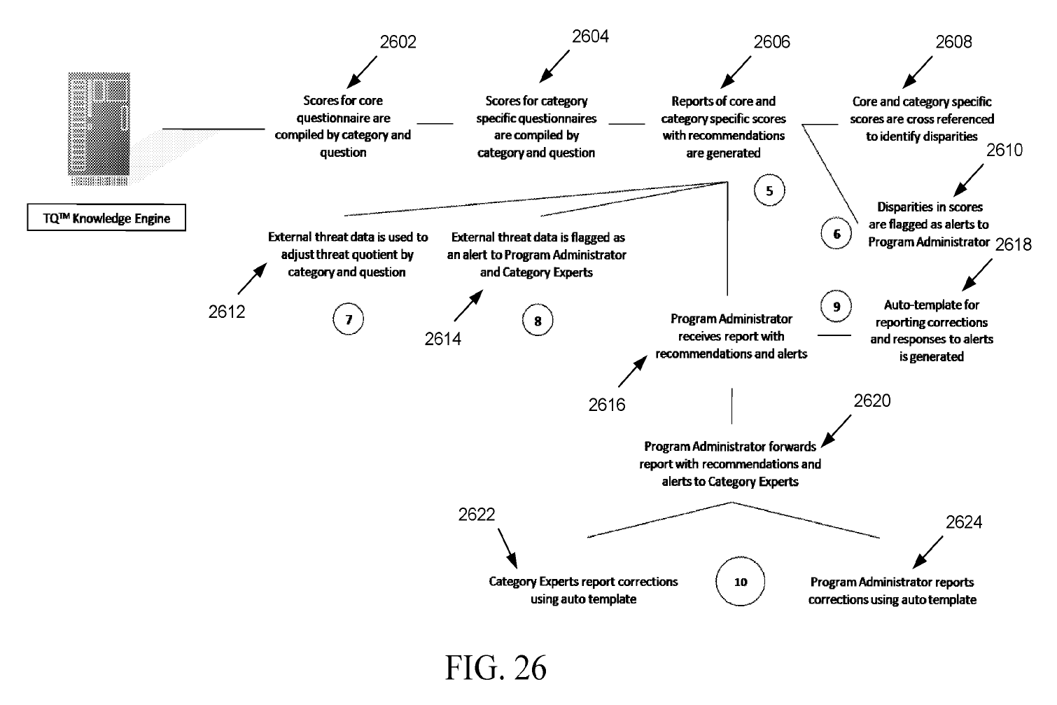

FIG. 26 is a continuation of the process diagram of FIG. 25 showing interaction with and processing performed by the system 2502. Scores for the core questionnaire are compiled by category and question 2602. Scores for category specific questionnaires are compiled by category and question 2604. Reports of core and category-specific scores with recommendations are generated 2606. The school system 2502 of FIGS. 25 and 26 can come preloaded with risk categories for a school setting including event path analysis and critical node analysis values already in place. By simply completing the core and category specific questionnaires, the knowledge engine can generate reports and recommendations.

Core and category-specific scores are cross-referenced to identify disparities 2608. Disparities can be flagged and alerts sent to the program administrator 2610. External threat data (e.g., data supplied by school) is used to adjust threat quotient by category and question 2612. External threat data is flagged as an alert to the program administrator and category experts 2614. The program administrator receives a report with recommendations and alerts 2616. Templates of reporting corrections and responses to alerts are automatically generated 2618.

The program administrator forwards the report with recommendations and alerts to category experts 2620. The category experts report corrections using the automatically generated templates 2622. The program administrator reports corrections using the automatically generated template 2624.

FIG. 27 is a chart showing an exemplary threat continuum analysis of the performance criteria for a school mass shooting/hostage taking risk event category, in accordance with the present disclosure. Each column represents a phase or stage of the threat continuum (i.e., deter, detect, prevent, respond, mitigate). Rows in each column list the performance criteria relevant to each phase. This correlation between threat continuum phase and individual performance criteria permits analysis of performance criteria relative to a specific phase along the threat continuum.

FIGS. 28 and 29 show exemplary risk event category weighting criteria and weighting, in accordance with the present disclosure. In FIG. 28, the columns represent risk category, vulnerability and consequence. In each event category row, criteria are identified that feed into a weighting and quantification of the risk events.

In FIG. 29, the rows for each event category have been populated with weighting values according to the weighting criteria. Also, weighting values can be verified and validated by internal or external sources, for example, by an internal panel of category experts, an external panel of category experts, a database of previously determined category weightings, or a combination of the above.

FIG. 30 is an exemplary computer generated arson event action checklist in accordance with the present disclosure. During an arson event, the system can generate the checklist of FIG. 30 to guide the response effort. A user of the system would simply need to input that an arson event is in progress and the system can respond with the appropriate checklist (i.e., FIG. 30). Also, an automated fire detection system could initiate automatic fire suppression equipment, signal an evacuation of the appropriate areas and signal the system to generate the arson/fire checklist to be provided as output.

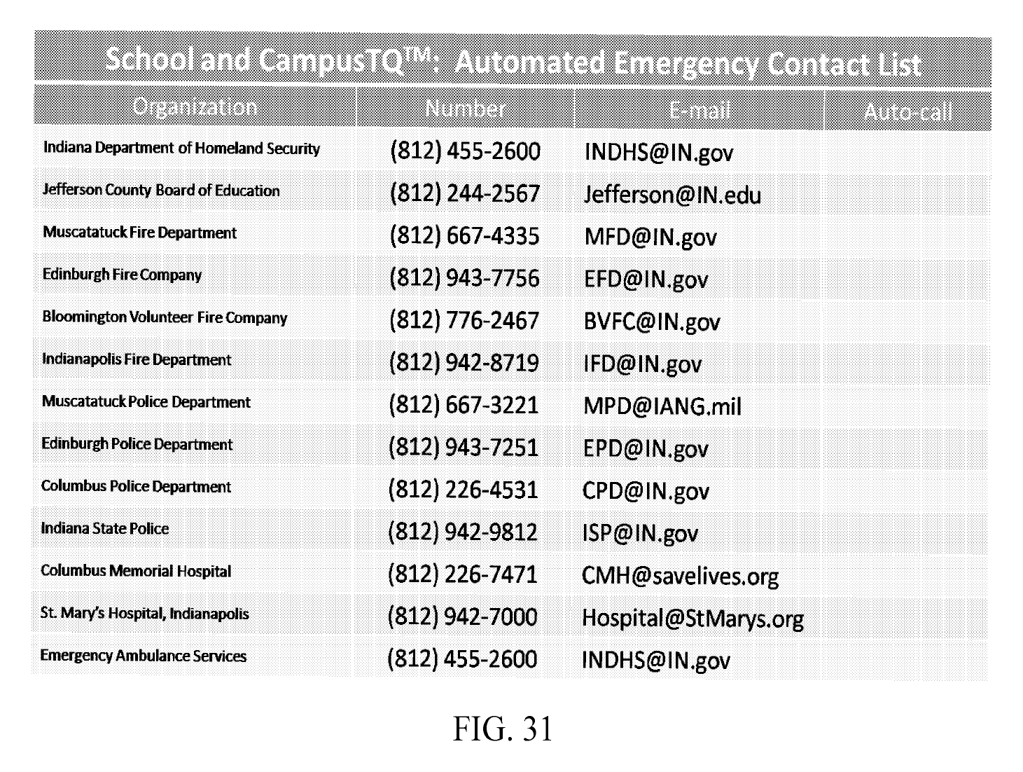

FIG. 31 is an exemplary computer generated automated emergency notification call list in accordance with the present disclosure. The emergency notification call list can be used by a person to make calls to the appropriate people or agencies. Alternatively, or in addition to a manual approach, the system could automatically place calls, text messages, emails, and/or other suitable communication message to the people and/or entities identified on the list.

FIG. 32 shows an exemplary spatial visualization of an event location in accordance with the present disclosure. The spatial visualization can be generated using public or private data map and/or image data. For example, Google maps or other sources available on the Internet can be used to render a graphical, spatial visualization of an event location. As shown in FIG. 32, several different levels of visualization detail can be provided, depending on the needs of an organization or of responders to an event (e.g., national map, regional satellite imagery, local satellite imagery, building layouts, or the like).

FIG. 33 shows an exemplary visualization of a target location in accordance with the present disclosure. If a more precise location of the event within a broader location is known, then a target location visualization can be generated that shows the event location in greater detail. As shown in FIG. 33, a campus satellite or aerial image can be shown along with a facility layout and indication of certain areas within campus (e.g., evacuation meeting points).

FIG. 34 shows exemplary computer generated incident management templates for display on a computer display and a wireless device display, in accordance with the present disclosure. For example, the display can include incident (or event) details such as start time, end time and emergency URL. Evacuation assembly areas can be shown. A description of the incident can be provided that tells the type of incident and response steps taken thus far (e.g., evacuation, notifications made and emergency URL generated). The display can also show command post information such as location, emergency radio frequencies, telephone numbers and officer in charge. First responder staging details can be displayed including location, emergency frequencies, telephone number, officer in charge and/or special instructions for first responders. The incident management display can be provided for display on a desktop or laptop computer. Also, the incident management screen can be adapted for display on a mobile or wireless device such as a Blackberry, iPhone, smartphone, cell phone, feature phone, netbook and/or the like.

The methods and processes discussed herein have been described as sequential for purposes of clarity of explanation. It will be appreciated the steps shown and described herein may be performed in a different order and/or in parallel, where appropriate.

It will be appreciated that the modules, processes, systems, and sections described above can be implemented in hardware, hardware programmed by software, software instruction stored on a nontransitory computer readable medium or a combination of the above. For example, a system for computerized event assessment, projection and control of complex systems (e.g., 100 or 200) can be implemented, for example, using a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, or another structured or object-oriented programming language. The sequence of programmed instructions and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core). Also, the processes, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any process capable of implementing the functions or steps described herein can be used to implement embodiments of the method, system, or a computer program product (software program stored on a nontransitory computer readable medium).

Furthermore, embodiments of the disclosed method, system, and computer program product may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the risk management and/or computer programming arts.

Moreover, embodiments of the disclosed method, system, and computer program product can be implemented in software executed on a programmed general purpose computer, a special purpose computer, a microprocessor, or the like.

It is, therefore, apparent that there is provided, in accordance with the various embodiments disclosed herein, computer systems, methods and software for computerized event assessment, projection and control of complex systems. Risks, threats or events projected, detected and/or visualized can include fires, bombings, shootings, natural disasters, terrorism, nuclear-biological-chemical emergencies, transportation emergencies, disease, food adulteration, suicide and/or other crimes.

While the invention has been described in conjunction with a number of embodiments, it is evident that many alternatives, modifications and variations would be or are apparent to those of ordinary skill in the applicable arts. Accordingly, Applicants intend to embrace all such alternatives, modifications, equivalents and variations that are within the spirit and scope of the appended claims.

What is claimed is:

1. A computer-based system for managing risk in a complex system, the computer-based system comprising:
a processor coupled to a data storage device; and
an interface adapted to exchange data with another device,
the data storage device having stored thereon software instructions that, when executed by the processor, cause the processor to perform operations including:
retrieving historical event data, risk event categories and performance criteria from the data storage device;
determining event paths for each event that presents a risk;
weighting critical nodes for each event path;
retrieving standards from the data storage device;
generating online surveys by triangulating standards;
issuing online surveys electronically using the processor to transmit the surveys to external systems via a computer network coupled to the interface; and
receiving online survey responses electronically and scoring the responses, using the processor, to generate performance reports including an assessment of risk potential for each risk event category.

2. The computer-based system of claim 1, wherein the operations further include generating projected events based on results of statistically processing the historical event data, the event paths, the critical node weighting and the survey results, the projected events representing potential risk scenarios derived from the statistical processing results and past event occurrences.

3. The computer-based system of claim 1, wherein the operations further include continuously harvesting event data using a computerized information gathering system.

4. The computer-based system of claim 1, wherein the operations further include calculating, using the processor, an event probability for each event that presents a risk.

5. The computer-based system of claim 1, wherein the operations further include calculating, using the processor, an adjusted threat quotient for each critical node in an event path.

6. The computer-based system of claim 1, wherein the operations further include calculating, using the processor, an estimate of event sequence interruption for each event that presents a risk.

7. The computer-based system of claim 1, further comprising an interface adapted to transmit performance reports to a wireless device.

8. The computer-based system of claim 1, further comprising an interface adapted to receive situational information about the complex system, and wherein the operations further comprise analyzing the received situational information and generating a response based on processing, with the processor, the situational information and the event paths, and outputting the response.

9. The computer-based system of claim 8, wherein the operations further include outputting the response to a display connected to the computer based-system.

10. The computer-based system of claim 8, wherein the operations further include outputting the response to a wireless device.

11. A computerized method of complex system event management, the method comprising:
triangulating and weighting risk event categories based on historical event data retrieved from a computer data storage;
determining and weighting performance criteria relevant to managing events for an organization;
constructing an electronic standards library based on standards retrieved from the computer data storage;
validating and testing performance criteria;
assessing client performance;
projecting future events; and
generating event management response recommendations.

12. The computerized method of claim 11, wherein the triangulating and weighting risk event categories includes:
triangulating available data;
populating an events database;
triangulating categories of risk events;
determining weighting criteria for each risk event category; and
weighting and ranking each risk event category.

13. The computerized method of claim 11, wherein the determining and weighting performance criteria includes:
reverse engineering past events;
analyzing each event along a risk continuum;
triangulating analysis results;
determining a weighting rationale;
weighting performance criteria of the risk continuum;
isolating indicators and warnings;
formulating an intelligence collection strategy; and
issuing alerts by event category.

14. The computerized method of claim 11, wherein constructing a standards library includes:
triangulating source data to determine minimum compliance standards and best practices related to each event;
comparing compliance standards and best practices with internally generated performance criteria;
identifying and filling any gaps between compliance standards and best practices and the performance criteria;
determining control questions adapted for use in online surveys;
converting standards data to a modified Delphi format and storing in an electronic database;
weighting a risk continuum value of each node along each event path; and
establishing a reporting taxonomy.

15. The computerized method of claim 11, wherein validating and testing performance criteria includes performing a multi-disciplinary review of data generated in the triangulating, determining and constructing steps, and testing event paths and performance criteria using simulations and real-world testing.

16. The computerized method of claim 11, wherein assessing client performance includes:
inputting performance assessment data; and
conducting a performance assessment.

17. The computerized method of claim 11, wherein projecting future events includes:
generating projected event paths for different categories of risk;
reverse engineering projected events;
accessing risk continuum analysis;
conducting a critical node analysis;
weighting critical nodes;
determining a relative value of each critical node; and
determining a win/lose outcome probability for each category of risk by executing an estimate of event sequence interruption.

18. The computerized method of claim 11, wherein generating event management response recommendations includes:
developing an event actions library based on performance criteria and projection of future events;
selecting an event action checklist based on type of event;
determining emergency uniform resource locator generation protocol;
generating emergency notification call lists;
presenting a spatial visualization of event;
identifying target location within the spatial visualization; and
generating incident management templates.

19. A computerized control system for real-time control of events associated with a complex system, the computerized control system comprising:
a processor having an information processing unit and a computer readable medium;
a database coupled to the processor, the database being adapted to store event risk assessment, projection and control information;
a display coupled to the processor and adapted to display event risk assessment, projection and control information generated by the processor;
one or more sensors each being adapted to provide a signal to the processor;
one or more actuators each being adapted to receive a control signal from the processor; and
an interface coupled to the processor and adapted to connect the processor to a computer network,
the computer readable medium storing instructions that, when executed by the processor, cause the processor to perform operations including:
identifying, characterizing and assessing risk associated with the complex system;
projecting event paths for each risk, each event path having one or more decision points;
calculating adjusted threat quotient values for each decision point along each event path;
monitoring sensor values;
determining whether a risk event is in progress; and
when a risk event is in progress, generating an action plan for responding to the risk event based on the adjusted threat quotient values.
